(19) United States
(12) Patent Application Publication
(10) Pub. No.: US 2026/0106490 A1
(43) Pub. Date: Apr. 16, 2026

(54) DOCKING STATION FOR A HUMANOID ROBOT

(71) Applicant: Figure AI Inc., San Jose, CA (US)

(72) Inventors: Ryan Benyshek, San Jose, CA (US); David McCall, San Jose, CA (US); Sydney Hardy, San Jose, CA (US)

(21) Appl. No.: 19/352,959

(22) Filed: Oct. 8, 2025

Related U.S. Application Data
(60) Provisional application No. 63/705,944, filed on Oct. 10, 2024.
(60) Provisional application No. 63/705,778, filed on Oct. 10, 2024.
(60) Provisional application No. 63/767,281, filed on Mar. 5, 2025.
(60) Provisional application No. 63/839,474, filed on Jul. 7, 2025.
(60) Provisional application No. 63/839,479, filed on Jul. 7, 2025.
(60) Provisional application No. 63/850,760, filed on Jul. 25, 2025.
(60) Provisional application No. 63/875,074, filed on Sep. 3, 2025.
(60) Provisional application No. 63/874,723, filed on Sep. 3, 2025.
(60) Provisional application No. 63/875,558, filed on Sep. 4, 2025.

(51) Int. Cl. H02J 50/00; G05D 1/661; G05D 109/12; H02J 50/10; H02J 50/40

(52) U.S. Cl. CPC H02J 50/005; G05D 1/661; H02J 50/10; G05D 2109/12; H02J 50/402

(57) ABSTRACT

The present disclosure provides a docking station for a humanoid robot having a torso, shoulders, and waist, comprising a base configured to support the humanoid robot and a stand assembly extending upward from the base and including an upper support configured to be positioned under the shoulders of the humanoid robot to at least partially support the weight when the humanoid robot is in a quasi-standing position on the docking station. The upper support comprises a pair of arms extending from a vertical support, each arm having a distal end configured to be positioned underneath a respective shoulder. The stand assembly further comprises a lower support configured to be positioned under the waist to provide additional support. The docking station further comprises a charging system configured to charge a battery.

### CROSS REFERENCE TO RELATED APPLICATIONS

This application claims the benefit of and priority to U.S. Provisional Patent Application Nos. 63/705,944 filed Oct. 10, 2024, 63/705,778 filed Oct. 10, 2024, 63/767,281 filed Mar. 5, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is hereby expressly incorporated by reference herein in its entirety.

### TECHNICAL FIELD

This disclosure relates generally to a docking station for a humanoid robot. Specifically, the disclosure pertains to a docking station that is configured to support, protect, charge, and/or calibrate the aforementioned humanoid robot when it is not in use.

### BACKGROUND

Humanoid robots are increasingly being developed for a wide range of applications and are designed to operate in complex, human-centric environments. These robots typically feature a bipedal design that includes a torso, a head, and two arms, thereby emulating the human form to perform tasks that involve manipulation and mobility. The anthropomorphic design of these robots enables them to navigate environments originally designed for humans, utilize tools and equipment created for human use, and interact in a natural manner with human operators. As the deployment of these advanced robots becomes more widespread, the need for efficient and practical infrastructure to manage them when they are not operational becomes increasingly significant. When not in use, a humanoid robot must be stored in a manner that is safe, secure, and energy-efficient. The storage solution must also take into consideration the mechanical stress on joints and actuators, the accessibility for maintenance operations, and the optimization of facility space utilization. Conventional methods for stowing humanoid robots, such as having them assume a sitting or lying position, are often suboptimal. These positions can be inefficient in terms of the floor space they occupy, which in turn limits the number of robots that can be stored within a given area. Furthermore, transitioning a robot from a sitting or lying position to a standing, operational state consumes a significant amount of its limited onboard battery power and can induce mechanical strain on its actuators and joints. The energy consumption associated with these state transitions directly reduces the available operational time of the robot once it is deployed. Other methods, such as utilizing overhead tethers or gantry systems for support, can be complex and may occupy equipment that could otherwise be used for active, operational robots. Additionally, these overhead systems demand substantial infrastructure modifications and present challenges in facilities with limited ceiling height or existing overhead obstructions. Therefore, a need exists for an improved system and method for docking a humanoid robot when it is not in use. The solution should optimize space utilization, minimize energy consumption during docking and undocking procedures, reduce mechanical wear on the robot's components, and provide integrated functionality for charging and maintenance operations.

### SUMMARY

The presently disclosed subject matter is directed to a docking station for a humanoid robot. Particularly, the docking station comprises a base configured to support the humanoid robot. The docking station includes a stand assembly extending upward from the base and including a vertical support and a support cradle coupled to the vertical support, the support cradle configured to be positioned under a waist of the humanoid robot when the humanoid robot is docked. The docking station includes an electrical assembly configured to wirelessly charge the humanoid robot when the humanoid robot is positioned on the base and engaged with the support cradle.

The presently disclosed subject matter is directed to a method of docking a humanoid robot. Particularly, the method comprises navigating the humanoid robot to a docking station. The method includes positioning the humanoid robot on a base of the docking station such that feet of the humanoid robot are positioned on the base. The method includes engaging a support cradle of the docking station with a waist of the humanoid robot by reducing power to knee actuators of the humanoid robot to allow the humanoid robot to move from a standing position to a quasi-standing position. The method includes wirelessly charging the humanoid robot through the base while the support cradle at least partially supports a weight of the humanoid robot.

The presently disclosed subject matter is directed to a system for autonomous robot management. Particularly, the system comprises a humanoid robot having a torso, leg assemblies, and an onboard battery. The system includes a docking station including a base with wireless charging capability and a stand assembly with a support cradle positioned to engage the humanoid robot below the torso. The system includes a control system configured to autonomously navigate the humanoid robot to the docking station and initiate wireless charging when the humanoid robot is mechanically supported by the support cradle.

In some embodiments, the docking station further comprises an upper support coupled to the vertical support and configured to be positioned under shoulders of the humanoid robot, the upper support comprising a pair of arms extending horizontally forward and outward from the vertical support to form a U-shaped support, and wherein the control system is configured to position the arms between the torso and respective upper arms of the humanoid robot underneath shoulder joints to provide additional mechanical support.

The presently disclosed subject matter is directed to a docking station for supporting a bipedal robot. Particularly, the docking station comprises a platform defining a docking area for receiving feet of the bipedal robot. The docking station includes a vertical support extending upward from the platform. The docking station includes an upper support coupled to the vertical support and configured to be positioned under shoulder joints of the bipedal robot. The docking station includes a lower support coupled to the vertical support below the upper support and configured to engage a pelvic region of the bipedal robot. The docking station includes wireless charging coils integrated into the platform and configured to inductively couple with receiver coils in the feet of the bipedal robot.

The presently disclosed subject matter is directed to a method of wirelessly charging a humanoid robot. Particularly, the method comprises detecting a low power state in the humanoid robot. The method includes autonomously navigating the humanoid robot to approach a docking station in a reverse direction. The method includes positioning the humanoid robot such that a support cradle of the docking station is inserted between upper leg assemblies of the humanoid robot and below a waist of the humanoid robot. The method includes transferring at least a portion of the humanoid robot's weight from leg assemblies to the support cradle. The method includes initiating wireless power transfer from charging coils in a base of the docking station to receiver coils in feet of the humanoid robot.

In some embodiments, detecting the low power state comprises continuously monitoring a state of charge of an onboard battery using a power management system, calculating a dynamically computed threshold based on a current distance from the docking station and an anticipated energy cost of traversing terrain to the docking station, and triggering autonomous navigation when the state of charge diminishes below the dynamically computed threshold.

In some embodiments, autonomously navigating the humanoid robot comprises accessing a stored operational environment map to identify a location of the docking station, calculating an energy-optimal trajectory that avoids mapped obstacles, approaching the docking station in a forward direction using forward-facing vision sensors, and executing a 180-degree turn to orient the humanoid robot away from the docking station before reversing toward the docking station using a rear-facing camera for precise alignment.

The presently disclosed subject matter is directed to an apparatus for storing and charging a humanoid robot. Particularly, the apparatus comprises a base assembly including a platform with integrated wireless charging transmitters and sidewalls defining a robot positioning area. The apparatus includes a support structure extending vertically from the base assembly and including an adjustable cradle configured to mechanically engage and support a waist region of the humanoid robot. The apparatus includes a power management system configured to establish wireless power transfer to the humanoid robot when the humanoid robot is positioned within the robot positioning area and mechanically engaged with the adjustable cradle.

In some embodiments, the adjustable cradle is shaped similar to a bicycle seat and includes a seat portion forming an upper surface configured to contact the waist region of the humanoid robot, the seat portion being inclined upward from a distal end to a proximate end to guide the humanoid robot onto the adjustable cradle, and further comprising a gusset extending upward from a clamp to the distal end of the seat portion and a lip at the distal end configured to restrain a pelvis of the humanoid robot from sliding out of the adjustable cradle.

The presently disclosed subject matter is directed to a robotic docking system. Particularly, the system comprises a humanoid robot including actuators, sensors, a battery, and wireless charging receivers positioned in feet of the humanoid robot. The system includes a docking station including a base with wireless charging transmitters aligned with the wireless charging receivers and a stand assembly with a support element configured to engage the humanoid robot at a waist level. The system includes a control architecture configured to execute an autonomous docking sequence including approach navigation, reverse positioning, mechanical engagement with the support element, and activation of wireless power transfer between the wireless charging transmitters and the wireless charging receivers.

In some embodiments, a docking station for a humanoid robot is provided. The docking station may comprise a base having a platform that forms a substantially level surface, with sidewalls extending around a back perimeter to define a docking area for the feet of the humanoid robot. A support structure may extend vertically from the base, to which a lower support cradle and an upper support are coupled. In some embodiments, the lower support cradle is shaped similar to a bicycle seat, with a seat portion that is inclined upward from a distal end to a proximate end to guide the robot's waist into position. This cradle may further include a gusset for structural integrity and a lip at the distal end configured to restrain the robot's pelvis. The upper support may comprise a pair of arms extending horizontally forward and outward to form a U-shaped support, positioned to extend into the gaps between the robot's torso and upper arms, underneath the shoulder joints, thereby providing additional stability. The base further integrates an electrical assembly for charging, which comprises wireless charging pads or inductive transmitter coils configured to align and couple with receiver coils in the feet of the robot. This assembly can include an AC-to-DC converter and thermal management systems, such as airflow channels, to enable higher charging rates.

In some embodiments, a method for autonomous docking and charging of a humanoid robot is described. The process is initiated by a power management system within the robot that detects a low power state of an onboard battery, which may be determined by a dynamically computed threshold based on the robot's distance to the docking station and the energy cost of traversal. Upon detection, the robot accesses a stored operational environment map to identify the docking station's location and calculates an energy-optimal trajectory that avoids mapped obstacles. The robot's control architecture then executes a docking sequence, wherein the robot approaches the station in a forward direction using forward-facing vision sensors, executes a 180-degree turn to orient itself away from the station, and then reverses toward the station using a rear-facing camera for precise alignment of its feet with the wireless charging transmitters on the base.

In some embodiments, once alignment is achieved, the robot engages with the support structure. The robot executes a controlled declination motion, coordinating actuation of its hip and knee joints to lower its upper body along a substantially vertical vector, transitioning from a standing position to a quasi-standing position where the support cradle at least partially supports the robot's weight. This motion brings the robot's waist into physical contact with the support cradle. Precise positional adjustments may be guided by continuous tactile feedback from force-torque sensors until alignment posts on the support cradle engage with corresponding concave recesses on the robot's waist. Upon successful docking, the robot transmits a digital handshake signal via a low-power wireless protocol to the docking station to confirm readiness for power transfer. In response, the station energizes its inductive transmitter coils. The robot then transitions into a low-power state by de-energizing non-essential systems, such as actuators for active balancing, while maintaining inductive coupling to wirelessly charge its battery.

### BRIEF DESCRIPTION OF THE DRAWINGS

The drawing figures depict one or more implementations in accordance with the present teachings, by way of example only, and not by way of limitation. These figures are intended to illustrate and not to restrict the scope of the disclosure. In the figures, like reference numerals refer to the same or similar elements. This convention is maintained throughout the drawings for consistency.

FIG. 1 is a perspective view of a plurality of humanoid robots, wherein each humanoid robot is supported by either a first embodiment of a docking station or a second embodiment of a docking station;

FIG. 2 is a perspective view of a first embodiment of the docking station shown in FIG. 1, wherein said docking station includes: (i) a base, (ii) a stand assembly with a vertical support, an upper support, and a lower support, and (iii) an electronics assembly;

FIG. 3 is a front view of the docking station of FIG. 2;

FIG. 4 is a left side view of the docking station of FIG. 2;

FIG. 5 is a top view of the docking station of FIG. 2;

FIG. 6 is a perspective view of the upper support of FIG. 2;

FIG. 7 is a top view of the upper support of FIG. 2;

FIG. 8 is a front perspective view of the upper support of FIG. 2;

FIG. 9 is a right side view of the upper support of FIG. 2;

FIG. 10 is a perspective view of the lower support of FIG. 2;

FIG. 11 is a top view of the lower support of FIG. 2;

FIG. 12 is a right side view of the lower support of FIG. 2;

FIG. 13 is a diagram illustrating an environment and a network in which one or more humanoid robots may operate, connect, command and/or be commanded by, control and/or be controlled by, and/or interact;

FIG. 14 is a block diagram illustrating components of the humanoid robot of FIGS. 1 and 13;

FIG. 15 is a perspective view of a humanoid robot of FIGS. 1, 13-14;

FIG. 16 is a diagram illustrating actuators contained within the humanoid robot of FIGS. 1 and 13-15 and the corresponding rotational axes of said actuators;

FIG. 17 is an example map of the operational environment of the humanoid robot of FIGS. 1 and 13-16;

FIG. 18 is a side view of the humanoid robot of FIGS. 1 and 13-16, initially approaching the docking station;

FIG. 19 is a side view of the humanoid robot of FIGS. 1 and 13-16, in a subsequent stage of approaching the docking station;

FIG. 20 is a side view of the humanoid robot of FIGS. 1 and 13-16 in a docked configuration with the docking station;

FIG. 21 is a perspective view of the humanoid robot in the docked configuration with the docking station of FIG. 20;

FIG. 22 is a front view of the humanoid robot in the docked configuration with the docking station of FIG. 20;

FIG. 23 is a top view of the humanoid robot in the docked configuration with the docking station of FIG. 20;

FIG. 24 is a flow diagram of an example docking and recharging process that can be performed by the humanoid robot and docking station of FIGS. 1 and 13-16.

FIG. 25 is a perspective view of the humanoid robot of FIG. 1 on a second embodiment of a docking station; and

FIG. 26 is a perspective view of the second embodiment of the docking station.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be universally applied. Rather, in some embodiments, such features may be arranged in a different manner and/or order than shown in the illustrative figures. Additionally, the inclusion of a structural or method feature in a particular figure is not meant to imply that such a feature is present in all embodiments and, in some embodiments, may not be included or may be combined with other features.

### A. INTRODUCTION

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for: (i) advanced robots capable of handling undesirable and hazardous tasks, (ii) advanced robots capable of generating data that can be utilized to develop cutting-edge artificial intelligence models (e.g., LLMs, VLMs, VLAs, and/or BAMs) to enable these robots to operate autonomously in human-centric environments, or (iii) advanced robots capable of partial or complete autonomy.

One aspect of advanced robotic autonomy is to provide the advanced robot with the capability to replenish its own internal power reserves. As the robot operates, its onboard electrical and electromechanical systems consume power. As such, the robot should be provided with sufficient reserves of power to prevent motor, sensor, or processor malfunctions that could lead to a fall, which could potentially damage the robot and/or people and objects in the robot's environment. Furthermore, the robot should be able to be recharged and return to work without a human presence or distracting a human from other higher-level tasks that the robot may be freeing them to perform.

The disclosed docking station with wireless charging capabilities solves or improves upon the shortcomings of conventional (e.g., manual plug-in) charging systems. As such, the docking station is designed to be locatable by the robot, provide recharging power to the robot, and passively support the weight of the robot (e.g., allowing some or all of the robot's power-consuming electrical and electromechanical systems to at least partly shut down during recharging, thereby reducing recharging time and preventing falls). The disclosed docking station provides a support cradle configured to engage the robot proximal to the robot's waist, and wireless (e.g., inductive) charging pads in a base upon which the robot places its feet (e.g., which include inductive receiver coils). In general, the disclosed docking station allows the robot to walk up to the docking station, turn around, and walk backwards onto the base such that the support cradle at least partly surrounds the robot's waist. The robot can then relax its knee actuators in a slightly “squatted” configuration to rest its torso upon the support cradle at the waist, while the robot's feet rest upon the base to receive recharging power.

Various embodiments of the docking station are designed to: (i) support the weight of the robot, (ii) stabilize the robot in a substantially upright (e.g., standing) configuration while some or all of the robot's onboard systems and actuators are in low or no-power mode, (iii) provide wireless power to the robot for operation and/or recharging its onboard power reserves, and (iv) be portable. This configuration helps enhance the productivity, autonomy, and flexibility of humanoid robotic operations. For the above reasons, the design and arrangement of the disclosed docking station and complementary features of the robot provide the disclosed robot with substantial benefits over conventional robots and charging systems.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1.

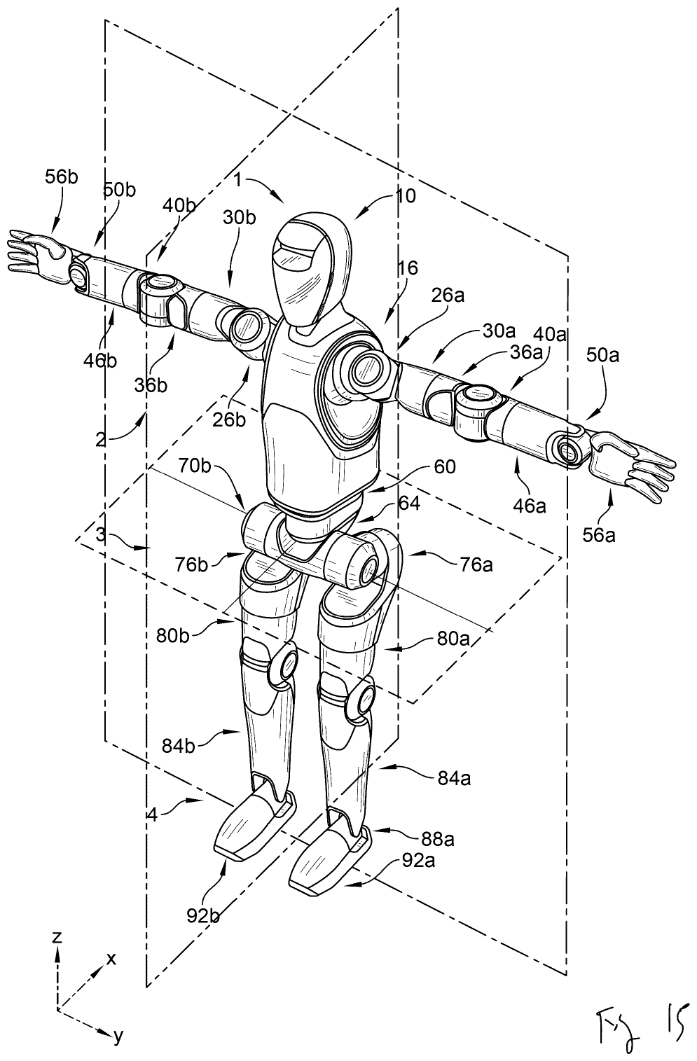

Extended State: a state of the robot with the arms extended outward laterally at the shoulder (as illustrated in FIG. 15) and oriented with the palms of the hands substantially facing downward and the fingers pointing in a substantially outward direction, where the central and lower portions of the robot remain in a neutral state.

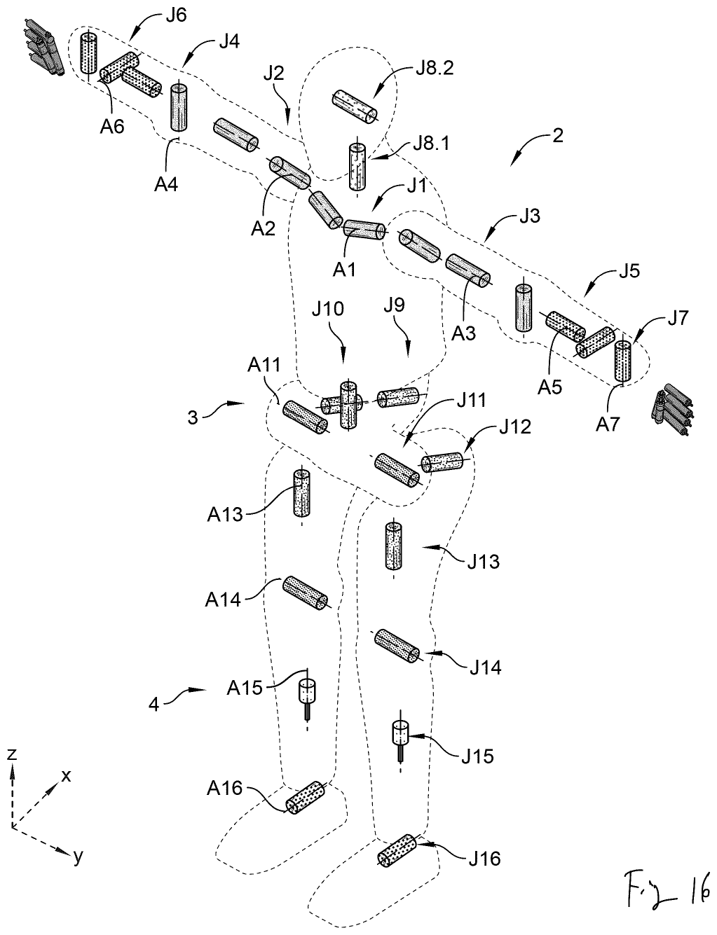

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 15) is a vertical plane positioned at a midway point between the left and right legs and the left and right arms and contains a rotational axis A₁₀ of a torso twist actuator (J10) (e.g., as illustrated in FIG. 16) located in the spine 60 of the robot 1 and divides the left and right sides of the robot 1 (e.g., as illustrated in FIG. 15). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 15-16), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁)) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (PT) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 15, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 15 illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 16, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

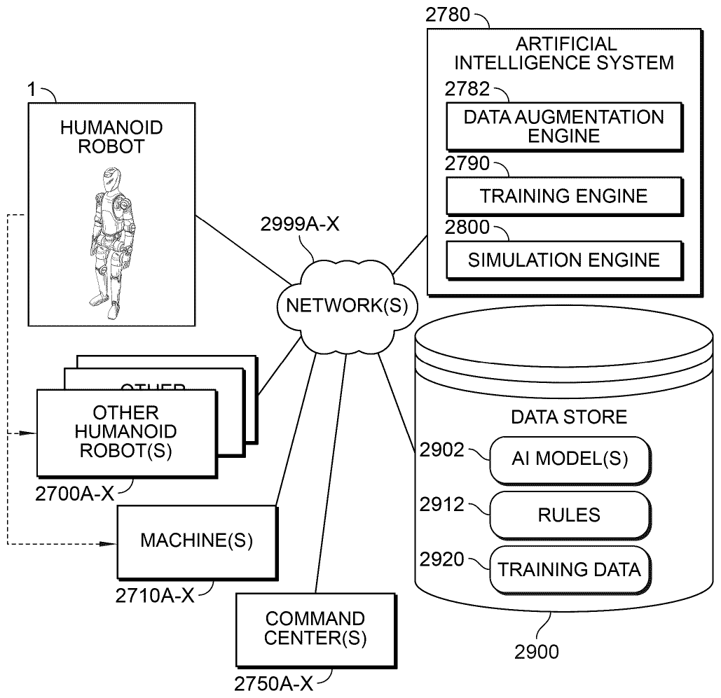

FIG. 13 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may be the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-based AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands of AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 13 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

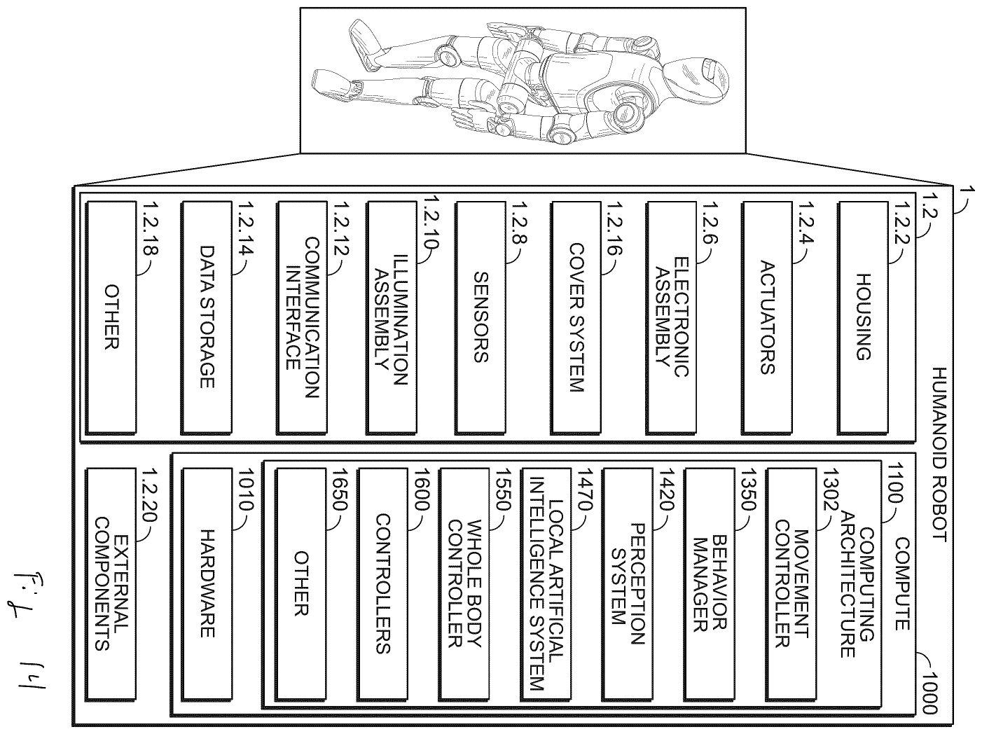

FIG. 14 is a block diagram of a humanoid robot 1 that includes a variety of architectures and other components that may include: (i) a mechanical/electrical architecture 1.2 that includes housings 1.2.2, actuators 1.2.4, an electronic assembly 1.2.6, sensors 1.2.8, a communication interface 1.2.12, an illumination assembly 1.2.10, data storage 1.2.14, a cover system 1.2.16, external components 1.2.20, and other components 1.2.18, and (ii) a compute system 1000 that includes a computing architecture 1100 including instructions to be executed on computing hardware 1010 comprising at least one processor.

### a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

### i. Robot Components

In addition to the general systems, assemblies, components, and parts described above, the humanoid robot 1 in the illustrative embodiment shown in FIG. 15 may include the following systems, assemblies, components, and parts, which can be broadly categorized into three regions. As shown in FIG. 15, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 15, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as checks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), and (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

### 2. Torso

The torso assembly 16 disclosed in this Application is designed to be a component within a robot system, for example, a versatile and highly-functional humanoid robot. The torso assembly 16 represents a sophisticated integration of structural, mechanical, and electronic subsystems. Said torso assembly 16 extends between the waist 60, the shoulders 26, and the head/neck assembly 10 and is designed to: (i) provide said robot 1 with a generally humanoid shape, (ii) provide structural and operable support for the arm assemblies 5 and the head/neck assembly 10, and (iii) house and protect the arm actuators and an electronic assembly (e.g., a battery, a computing device, a power distribution assembly, sensors, etc.). The multifunctional nature of the torso assembly 16 involves careful consideration of space allocation, thermal management, and structural integrity. To effectively house and protect said arm actuators and the electronic assembly, the torso 16 has a torso housing 162 that is comprised of: (i) a front skeleton 164, (ii) a rear skeleton 166, (iii) a shell assembly 172, and (iv) a rear interface panel 178. Each component of the torso housing 162 serves specific structural and functional purposes while contributing to the overall system integration.

Unlike conventional robots, the torso 16 is purposely designed with a complex geometry. The geometric complexity serves multiple functional purposes beyond aesthetic considerations. For example, the torso 16 has a quasi-trapezoidal prism configuration, wherein the frontal extent of the torso 16 is substantially smaller than the back extent of the torso 16 and the shrouds that extend between the frontal extent and back extent are angled (not parallel) in relation to one another. This geometric arrangement optimizes the robot's workspace while maintaining structural efficiency. This quasi-trapezoidal prism configuration is beneficial because it helps increase the robot's range of motion and, specifically, its ability to reach across its body. The cross-body reaching capability is particularly valuable for bimanual manipulation tasks. Additionally, a lower torso extent (e.g., within a bottom ⅓ portion of the height of the torso 16) is larger in width and volume than an upper torso extent (e.g., positioned within a top ⅓ portion of the height of the torso 16). This volumetric distribution allows for optimal placement of heavier components such as batteries and computing systems in the lower portion, thereby lowering the robot's center of mass. The torso 16 consequently tapers outwardly and downwardly between its upper and lower extents or portions. The tapering profile contributes to both structural stability and aesthetic appeal. Finally, the depth of the torso 16 (as defined between the front and rear walls or outer surfaces of the torso 16) does not substantially change between the bottom of the arm tubes and the lowest extent of the torso 16. This consistent depth profile simplifies manufacturing while maintaining adequate internal volume. This configuration of the torso 16 is beneficial over conventional robots—especially conventional robots having a dissimilar upward V-shaped torso—because it provides the robot 1 with a number of advantages, including: (i) making the robot 1 more stable while operating and performing tasks, (ii) increasing the volume contained within the torso 16 for positioning of other valuable components (e.g., batteries, power supplies, computing device, and sensor assemblies), (iii) preventing the front of the torso 16 from having bulges, projections or protrusions which can limit the robot's cross-torso reach, and (iv) eliminating bulges, projections or protrusions from being positioned in the rear of the torso 16 which can adversely impact the robot's center of mass. The optimized mass distribution contributes to improved dynamic performance during locomotion and manipulation tasks.

It is desirable to utilize a front skeleton 164 and a rear skeleton 166 to: (i) transfer loads from one side of the torso 16 to the other side of the torso 16, (ii) to allow an extent of the skeleton to be removed to allow for assembly and servicing of the electronic assembly, and (iii) reduce manufacturing complexities. The modular skeletal structure facilitates both initial assembly and subsequent maintenance operations. In other embodiments, the front and rear skeletons 164, 166 may be combined into a single unitary unit. The unitary construction approach offers certain structural advantages in terms of rigidity and load distribution. In this embodiment, the electronic assembly may be inserted from the bottom before the waist 60 is coupled to said skeleton. The bottom-loading configuration demands careful sequencing of assembly operations. This embodiment would allow for a reduction in the materials utilized in the torso 16, as said unitary skeleton may be made from a single integrated piece and could more effectively transfer loads between aspects of said skeleton. The load transfer efficiency of a unitary skeleton can improve overall structural performance. However, the limited space contained within the opening formed in the waist 60 will complicate the assembly of the robot 1 and will likely significantly increase manufacturing complexities associated with fabricating said unitary skeleton. The manufacturing challenges include both tooling considerations and quality control considerations. Nevertheless, this application contemplates utilizing a single, unitary skeleton, a skeleton that is comprised of multiple components (e.g., front and rear), or a skeleton that is comprised of multiple parts (e.g., front, rear, left side, and right side). The choice of skeletal configuration may be optimized based on production volume, manufacturing capabilities, and serviceability. In further embodiments, the rear skeleton 166 may be omitted in its entirety because said front skeleton 164 may be sufficient to effectively transfer said loads that are experienced by said robot 1. The structural analysis determines the minimum skeletal configuration for adequate load bearing.

### 3. Arm Assemblies

The humanoid robot 1 also includes a shoulder 26 that is coupled to an actuator J1 that is substantially positioned within housing 162 of the torso 16. The J1 actuator provides the primary degree of freedom for arm rotation about the shoulder axis. Said J1 actuator may be: (i) positioned within an arm tube that extends across the entirety of the torso 16, or (ii) coupled to a plate that is formed as a part of the skeleton or the exoskeleton of the robot 1. Each mounting configuration offers distinct advantages in terms of load distribution and assembly complexity. The use of an arm tube may be useful because it can help distribute the torque and other forces exerted on the robot's arms 5 to the robot's torso 16. The distributed load path reduces stress concentrations at mounting points. However, said arm tube undesirably minimizes the amount of space contained within said torso 16 for computers, batteries, and other sensors. The space constraints imposed by the arm tube must be carefully considered during system design. Thus, it may be desirable to only use a plate that is formed as a part of the skeleton or the exoskeleton of the robot 1. The plate mounting approach maximizes internal volume availability while maintaining adequate structural support.

The positional relationship of the output of the J1 actuator places the arm output mount of the output adaptor of the J1 actuator at an upward angle in relationship to the transverse plane, and potentially at a rearward angle in relation to the coronal plane. These angular orientations are optimized for the robot's typical working envelope. This positional relationship of J1 may cause the shoulder output mount of the shoulder actuator J2 to be positioned at an upwardly angle relative to the transverse plane. The angular relationships between actuators influence the overall kinematic performance of the arm assembly 5. This allows the arm singularity to be beneficially positioned between 5 and 25 degrees upward relative to the transverse plane and potentially between 5 and 25 degrees rearward in relation to the coronal plane. The singularity positioning minimizes the occurrence of singularities within the robot's primary workspace. Further, the range of motion for: (i) the arm actuator J1 is between 180 degrees and 270 degrees, (ii) the shoulder actuator J2 is between 120 degrees and 180 degrees, (iii) the humerus actuator is between 190 degrees and 360 degrees, and (iv) the elbow actuator is between 120 degrees and 180 degrees. These range specifications provide sufficient motion capability for most manipulation tasks while avoiding mechanical interference. These ranges of motions along with the location of the singularity allow the robot 1 to have a sizeable workable area and reduces the need to twist the spine, while minimizing space for battery and computer storage. The optimized kinematic configuration balances workspace with internal space utilization.

It should also be understood that the preferred arrangement of components in the shoulders 26 includes utilizing the housing of the shoulder 26 as the housing for the shoulder actuator J2. The integrated housing design eliminates redundant structural elements. In other words, the shoulder actuator J2 lacks a separate housing. This design approach reduces both weight and assembly complexity. This is beneficial because it reduces space and weight. The weight reduction contributes to improved dynamic performance and energy efficiency. Additionally, the configuration of the actuators allows for wires to be internally routed through the center through-bore of said actuators. The internal routing protects wiring from external damage and interference. This is beneficial because it reduces external wiring, and thus increases durability. The protected wiring configuration enhances system reliability over extended operational periods. Further, the arm actuator J1, shoulder actuator J2, humerus actuator, and the elbow actuator are configured to have a common size, torque, common parts, and are assembled in the same manner. The standardization of actuator components simplifies inventory management and maintenance procedures. This design reduces manufacturing times, reduces specialized parts, and allows the robot 1 to be more easily manufactured. The manufacturing efficiency gained through standardization contributes to overall system cost reduction. Finally, integrating the hardstops within the actuators allows for a beneficial reduction in the size of said actuators. The integrated hardstop design eliminates the need for external limiting mechanisms.

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

### b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness to perform such a diverse array of generalized tasks.

### i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table.

TABLE 1

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

### c. Compute

As illustrated in FIG. 14, the compute system 1000 may comprise any combination of hardware, software, and circuitry to perform various computing functions that enable the humanoid robot 1 to operate semi- or fully-autonomously. Specifically, the compute system 1000 includes: (i) compute hardware 1010, and (ii) a computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

### i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### E. DOCKING STATION

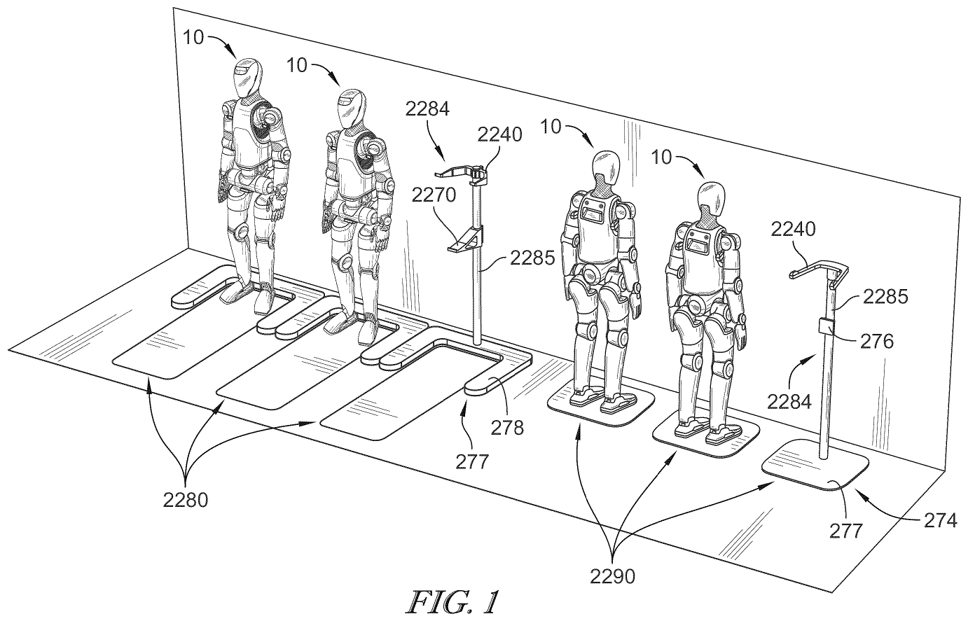

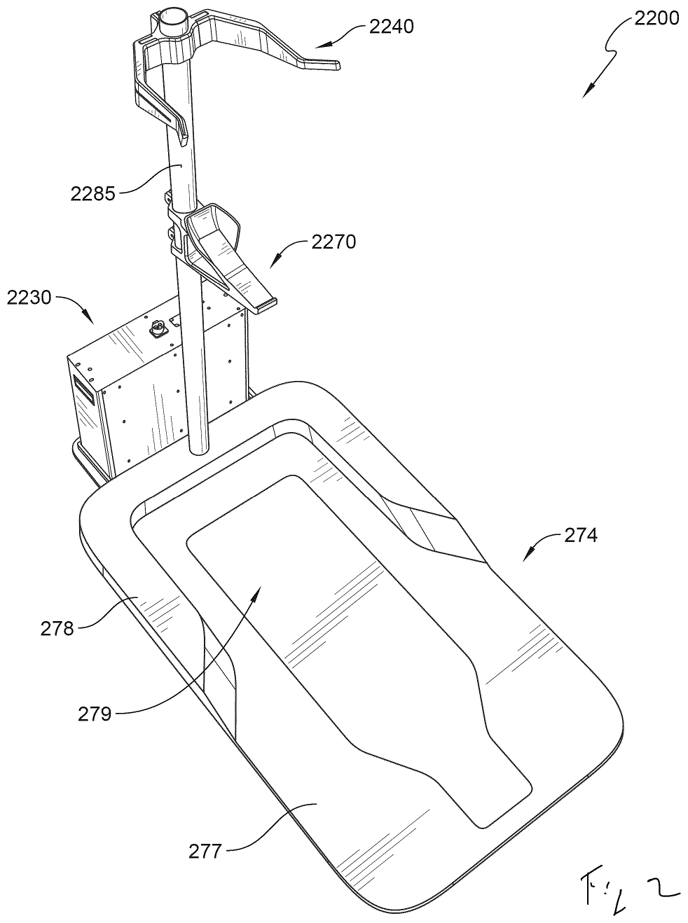

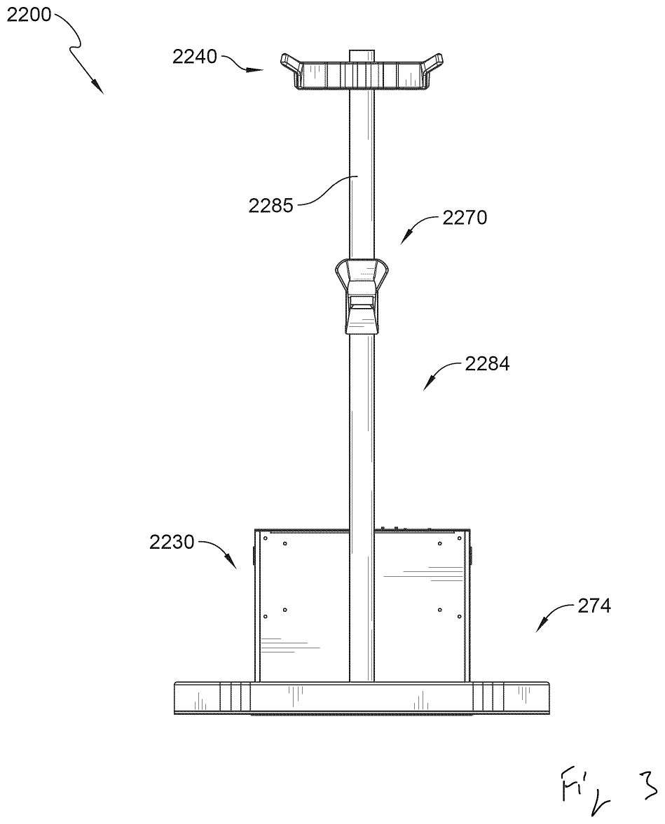

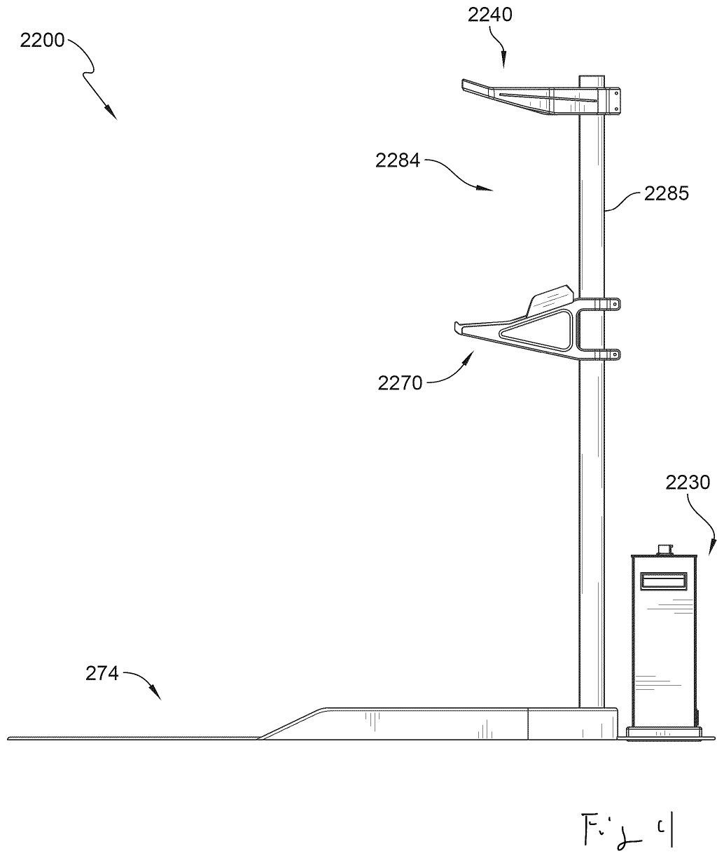

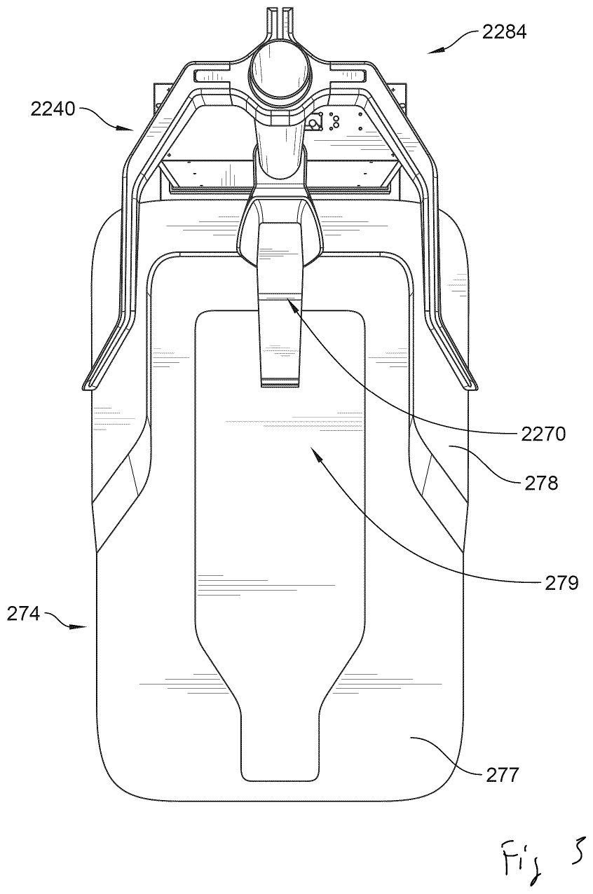

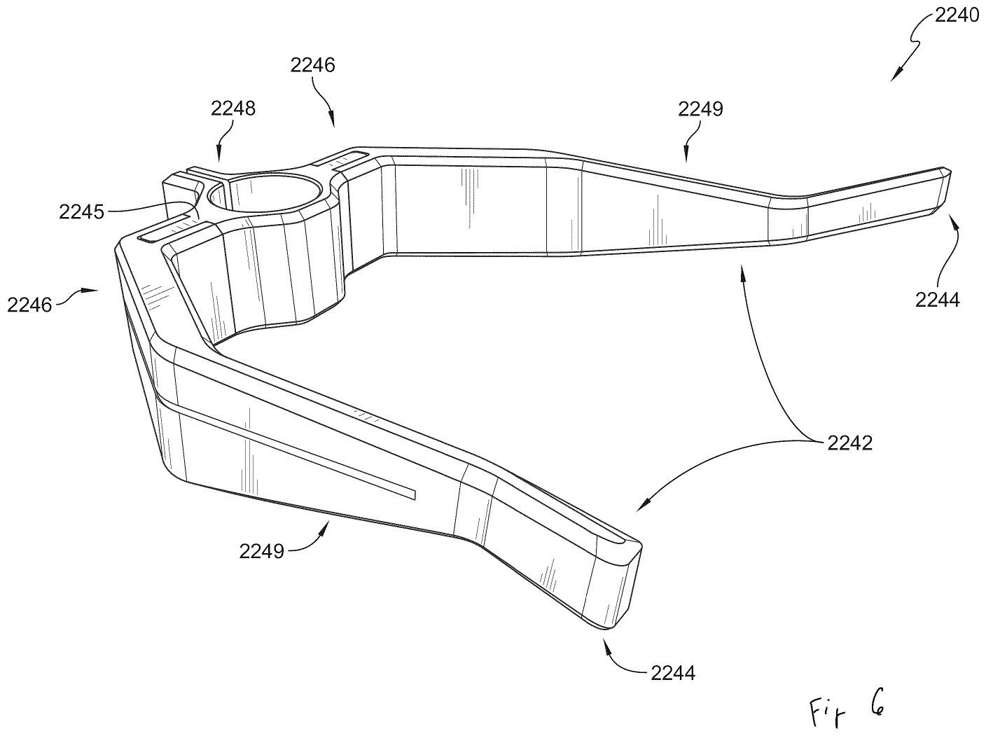

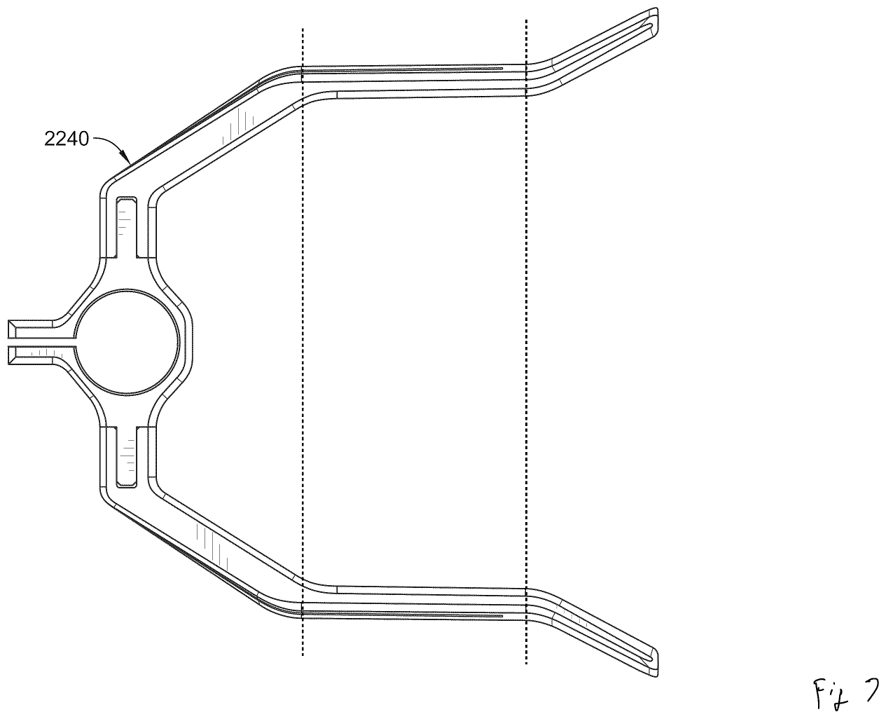

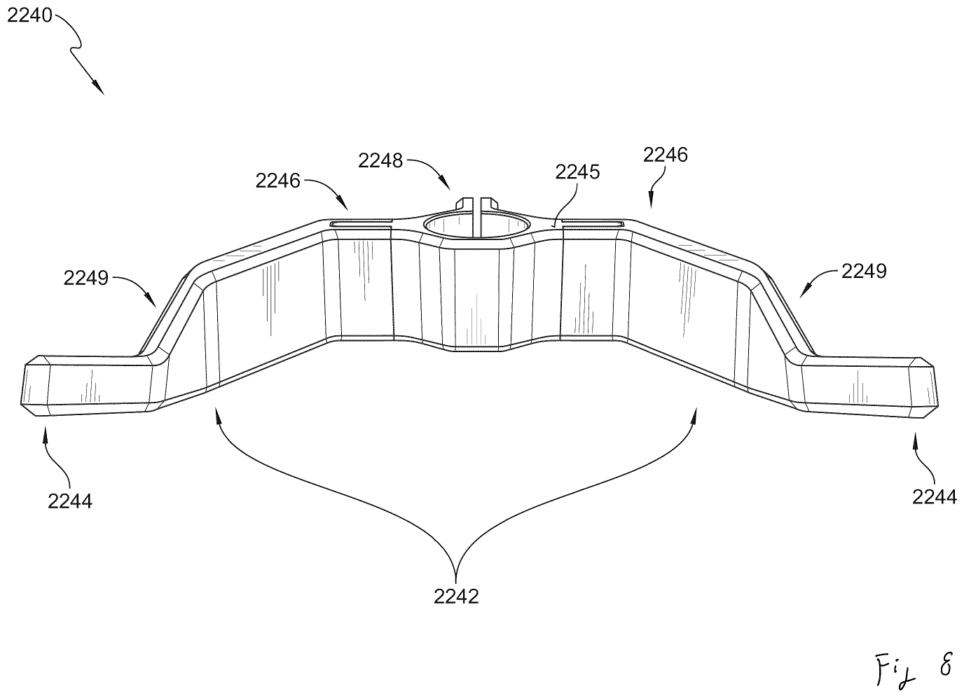

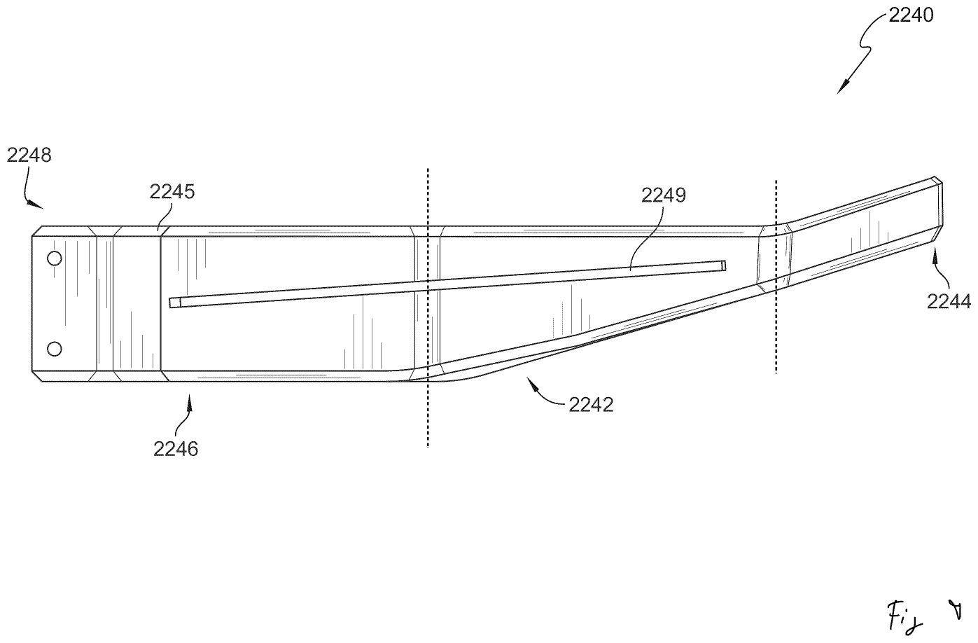

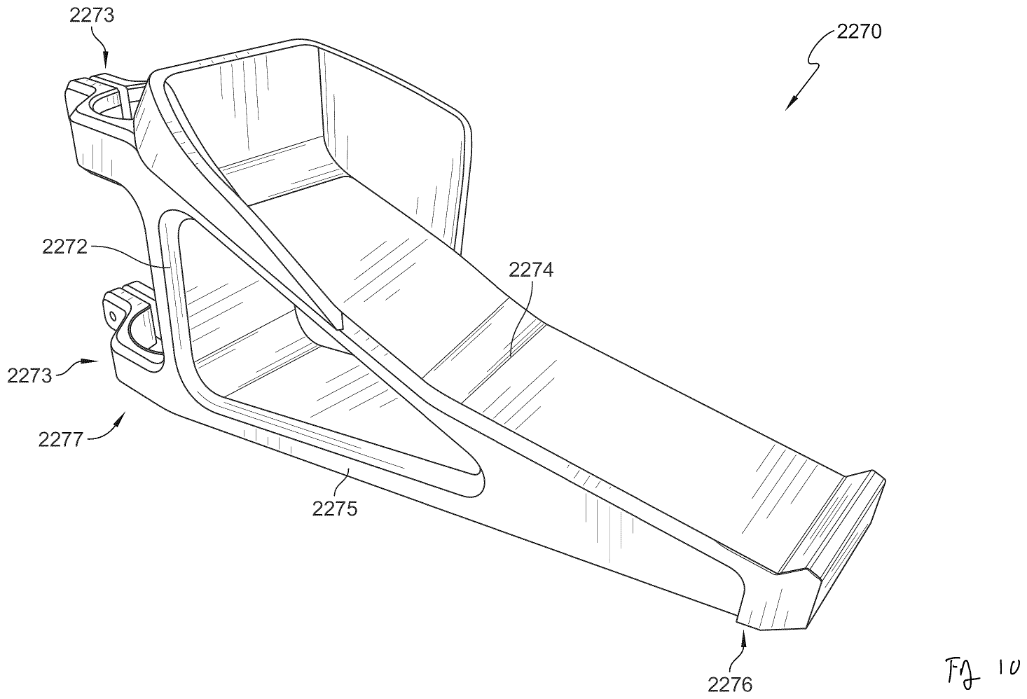

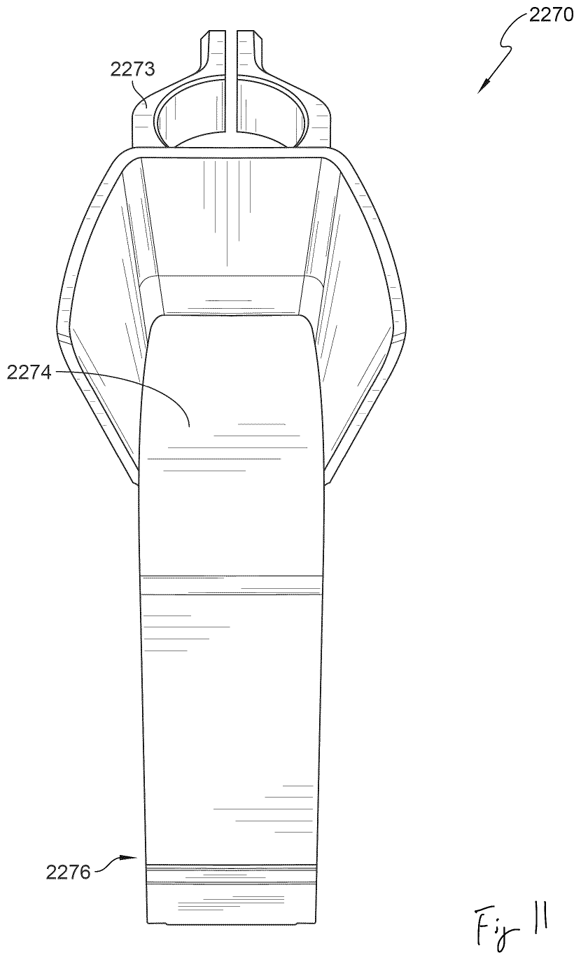

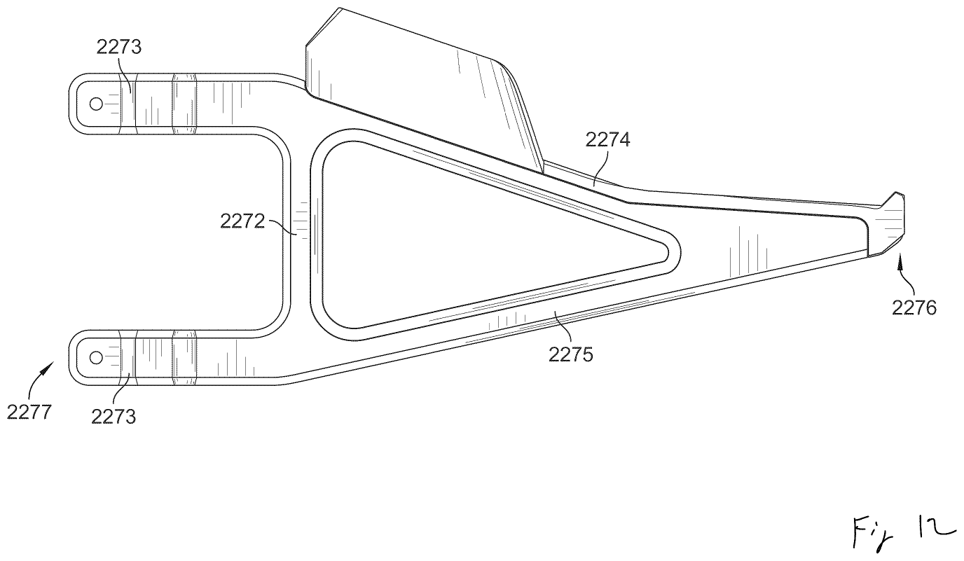

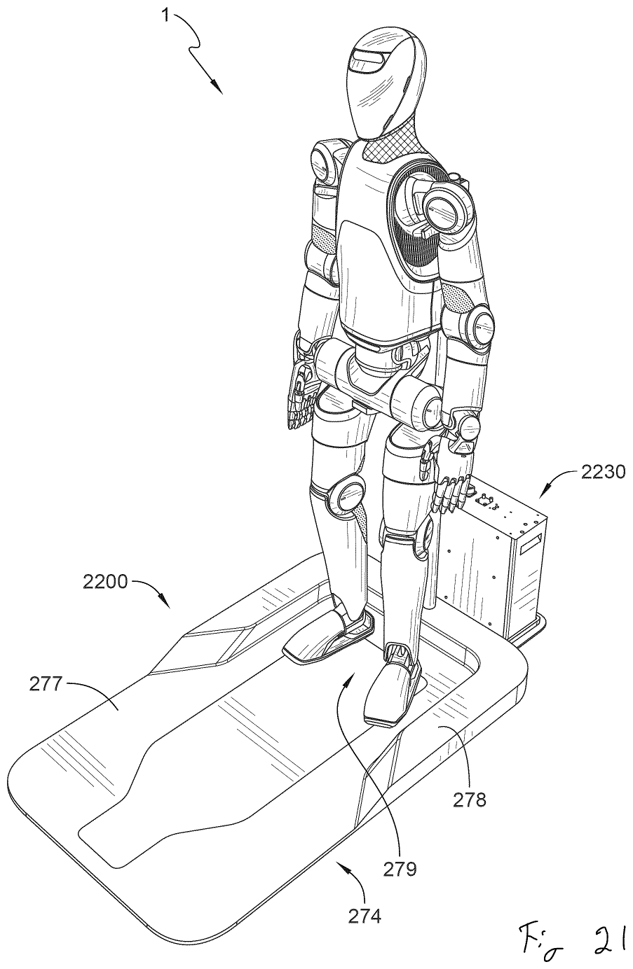

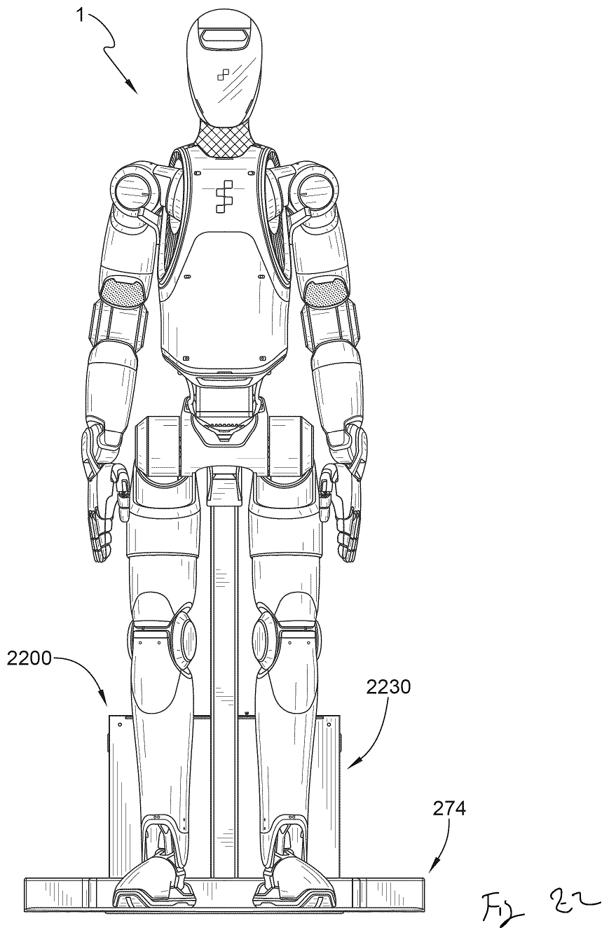

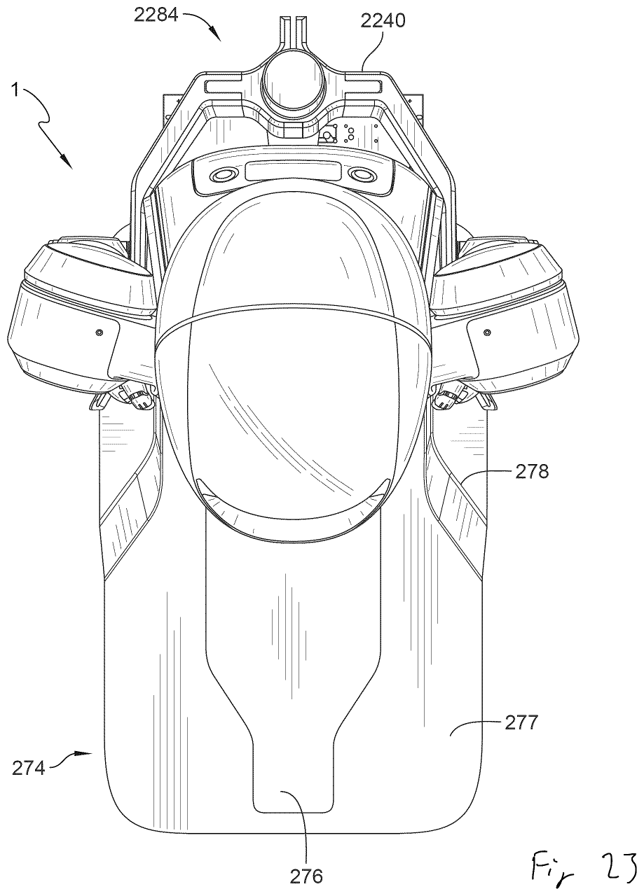

As shown in FIGS. 1-12 and 18-23, the docking station 2200 is shaped and configured to provide structural and mechanical support to the humanoid robot 1 when the robot 1 is not in use or performing tasks. The docking station 2200 represents a comprehensive solution for robot storage, maintenance, and charging operations. In some embodiments, the docking station 2200 is capable of at least partially (e.g., greater than 50% of the weight of the robot 1) and/or fully supporting (e.g., 100% of the weight of the robot 1) the robot 1. The variable support capability allows for different operational modes depending on maintenance. Said support of the robot 1 may be provided by supporting the robot 1 under the robot's arm assemblies 5, and specifically under the shoulder 26, and more specifically under the J2 actuator of said shoulder 26. The specific engagement with the J2 actuator leverages the robot's structural design for optimal load distribution. Additionally and/or alternatively, the docking station 2200 may support the robot 1 under its pelvis, which is coupled to its spinal actuators (which are in turn coupled to the torso 16). The multiple support points provide redundancy and allow for load distribution optimization. Supporting the humanoid robot 1 in a quasi-standing position provides certain advantages over configurations where the robot 1 sits or lies down. The quasi-standing position, for instance, represents a functional compromise between storage density and deployment readiness. Storing the humanoid robot 1 in a laying or sitting position can be inefficient with respect to floor space utilization and storage density. The floor space for prone or seated storage configurations can be substantially greater, for example, two to three times greater than the space for a quasi-standing storage configuration. Additionally, a significant amount of energy is expended to enable the robot 1 to pick itself up from a sitting or lay-down position, which is not expended from the quasi-standing position. The energy consumption for transitioning from prone to standing can consume several percent of total battery capacity. Reducing the amount of energy to move from the at-rest position to the working position is beneficial because it will allow the robot 1 to have a longer working life on a single charge and reduces strain on mechanical components. The mechanical wear reduction extends component lifetime and reduces maintenance.

To enable the robot 1 to be partially or fully supported by the docking station 2200, the docking station 2200 may include: (i) a base 2274, and (ii) a stand assembly 2284 including an upper support 2240 designed to couple to the upper portion of torso 16 of the robot 1 and a lower support or support cradle 2270 designed to couple to the waist 60 of the robot 1. The dual support configuration provides stable retention while minimizing stress on robot components. In other embodiments, the upper support 2240 and the support cradle 2270 may be combined into a single component that is positioned between the robot's pelvis and torso 16. The unified support design simplifies the docking station structure while maintaining functionality.

Additionally or alternatively, the upper support 2240 may be omitted and the docking station 2200 may only include the support cradle 2270 and/or a support cradle 2270 with external projections that are positioned on the outside of the robot's hips. The hip-engaging configuration provides an alternative support strategy for certain robot designs. Further, the support cradle 2270 may be omitted and the docking station 2200 may only include the upper support 2240.

In operation, the robot 1 may approach the docking station 2200 by: (i) walking forward towards the docking station 2200, or (ii) turning around and walking backward to the docking station 2200. The bidirectional approach capability provides operational flexibility in constrained environments. In either situation, the robot 1 may continue to walk to the docking station 2200 until: (i) either the front or rear of the torso 16 is positioned near a vertical support 2285 of the stand assembly 2284, and (ii) an extent of the upper support 2240 is positioned below an extent of the robot 1, preferably an extent of the robot's arm assembly 5, and most preferably an extent of the robot's J2 actuator that is housed within the robot's shoulder 26. The precise positioning ensures proper engagement between the robot 1 and docking station 2200. Once the robot 1 is in this position, then the power to said robot 1 may be turned off or said robot 1 may be put in a sleep mode. The power management options allow for different levels of readiness and energy conservation. In either case, the power to the actuators (e.g., knee actuators J14) may be stopped or reduced, which in turn will allow the robot 1 to move from a standing position to a quasi-standing position. The controlled power reduction ensures a smooth transition without damaging components. In said quasi-standing position the height of the robot 1 is reduced and the docking station 2200 partially supports or fully supports the weight of the robot 1. The height reduction in the quasi-standing position can be between 5% and 20% of the robot's full standing height. It should be understood that partially supporting or fully supporting the weight of the robot 1 involves the robot's shoulder 26 and/or pelvis resting on an extent of the upper support 2240 and/or support cradle 2270 of the docking station 2200. The physical contact between robot 1 and docking station 2200 provides both mechanical support and a potential electrical connection for charging.

In some embodiments, the docking station 2200 further comprises an electrical assembly 2230, and is configured to be in electrical communication with the robot 1. The electrical communication enables both power transfer and data exchange between the docking station 2200 and robot 1. In some embodiments, the electrical assembly 2230 includes an electrical source, and the docking station 2200 is configured to act as a charging station such that the electronic assembly 1.2.6 of the robot 1 is charged when the robot 1 is connected to the docking station 2200. The charging functionality eliminates the need for separate charging infrastructure. In some embodiments, the electrical assembly 2230 includes a controller, processor, memory and/or other components such that the electrical assembly 2230 is configured to act as a control center for the robot 1, capable of running diagnostics and/or communicating with the robot 1 while it is docked on the docking station 2200. The integrated control capabilities enable comprehensive maintenance operations without removing the robot 1 from storage.

### a. Base

As shown in FIGS. 1-5 and 18-23, in the illustrative embodiments the base 2274 is configured to be a substantially flat surface for the robot 1 to stand on when docked. The base 2274 provides both physical support and a positioning reference for the docking procedure. The base 2274 includes a platform 2277 that forms a substantially level surface for the robot 1 to walk onto and/or stand on. The level surface ensures stable robot positioning and prevents unintended movement. In some embodiments, the platform 2277 rests on an underlying surface and may be a relatively hard flat surface. The hard surface provides stable support without deformation under the robot's weight. In other embodiments, the platform 2277 may be a softer, cushioned padded surface depending on the needs of the docking station 2200. The cushioned surface can reduce impact forces during docking and provide vibration isolation. In some embodiments, the platform 2277 includes wireless charging pads as described in the below sections. The integrated charging pads eliminate the need for physical electrical connections. In the illustrative embodiments, the base 2274 includes sidewalls 2278 that extend around a back perimeter of the platform 2277 and define a docking area 2279 that the feet 92 and/or footprint of the robot 1 occupy when the robot 1 is docked with the docking station 2200. The defined docking area 2279 ensures consistent robot positioning for optimal support and charging alignment. The sidewalls 2278 may also act to guide the robot 1 into the docking area 2279 as the robot 1 approaches the docking station 2200. The guiding function of the sidewalls 2278 simplifies the docking procedure and reduces positioning errors. The base 2274 and/or the stand assembly 2284 may include a barcode or some other optical indicator 2276 that the robot 1 uses to determine the proximity and/or location of the docking station 2200. The optical indicators enable precise autonomous docking without external guidance systems. As described in a below section, the base 2274 may take a number of different embodiments. The configurability of the base 2274 allows adaptation to various facility layouts. In some embodiments, the platform 2277 is wholly or partially omitted. The platform omission may be appropriate for installations where the existing floor provides adequate support.

### b. Stand Assembly

As shown in FIGS. 1-12 and 18-23, the stand assembly or support means 2284 extends upward from the base 2274 and includes portions that are designed to be positioned under the robot 1. The vertical extension of the stand assembly 2284 positions support elements at optimal heights for robot engagement. Specifically, the stand assembly 2284 includes: (i) a vertical support 2285, (ii) an upper support 2240 that is coupled to the vertical support 2285 and is configured to be positioned under the robot's shoulders 26 (e.g., J2 actuator), and (iii) a lower support or support cradle 2270 that is coupled to the vertical support 2285 and is configured to be positioned under the robot's pelvis (e.g., under at least one and potentially two spinal actuators). The multi-level support configuration distributes the robot's weight across multiple structural points. It should be understood that in other embodiments, the vertical support 2285, upper support 2240, and/or support cradle 2270 may be omitted or replaced by an alternative design, configuration, or version. The modularity of the stand assembly 2284 allows for customization based on specific robot models and operational demands. Some of the possible alterations are disclosed below; however, it should be understood that this Application contemplates other designs, configurations, or versions that are capable of supporting, protecting, charging, and/or calibrating said humanoid robot when not in use. The flexibility in design ensures compatibility with evolving robot designs and operational needs.

### i. Vertical Support

The vertical support 2285 is oriented at a substantially 90-degree angle to the base 2274. The perpendicular orientation ensures efficient load transfer from the supported robot to the base. In the illustrative embodiment, the vertical support 2285 comprises an elongate, hollow cylindrical rod extending up from the base 2274 to a height approximately equal to an upper portion of the torso 16 of the robot 1 when the robot 1 is standing on the base 2274. The cylindrical geometry provides an optimal strength-to-weight ratio for vertical loading. The vertical support 2285 may be any suitable shape and/or material capable of supporting the upper and lower supports 2240, 2270 and/or at least partially supporting the weight of the robot 1. Material selection considerations include strength, stiffness, weight, and corrosion resistance. In the illustrative embodiment, the vertical support 2285 is coupled to the base 2274 at an upper surface of the sidewalls 2278. The coupling location provides stable attachment while maintaining the structural integrity of the base 2274. For example, the sidewalls 2278 may form an aperture through which the vertical support 2285 extends. The aperture mounting allows for removable installation of the vertical support 2285. In other embodiments, the vertical support 2285 may be coupled to the base 2274 through alternative methods. Alternative coupling methods may include welding, bolting, or integrated casting. In some embodiments, the support 2285 may be a separate piece unconnected from a base 2274, wherein said base 2274 may be omitted and the support 2285 may be formed with or secured to the floor or a wall. The wall or floor mounting options provide installation flexibility for various facility configurations.

### ii. Upper Support

As shown in FIGS. 1-12 and 18-23, the upper support 2240 is coupled to an upper end of the vertical support 2285 at a height approximately equal to an upper portion of the torso 16 of the robot 1 when the robot 1 is standing on the base 2274. The height positioning ensures engagement with the robot's shoulder region without excessive vertical movement. The upper support 2240 comprises a pair of arms 2242. The dual-arm configuration provides symmetric support distribution across both shoulders 26. A distal end 2244 of each arm 2242 extends horizontally forward and outward from the vertical support 2285 to form a U-shaped support coupled to the vertical support 2285 at a base 2245 of the U-shape. The U-shaped geometry provides lateral stability while allowing robot entry and exit. A proximate end 2246 of each of the two arms 2242 meets at the base 2245 and forms a clamp 2248 which encompasses the vertical support 2285. The clamping mechanism provides a secure yet adjustable attachment to the vertical support 2285. The clamp 2248 adjustably couples the upper support 2240 to the vertical support 2285 such that a height of the upper support 2240 on the vertical support 2285 is adjustable. The height adjustability accommodates robots of different sizes and configurations. In other embodiments, a different coupling mechanism may be used, or alternatively, the upper support 2240 may be a unitary component with the vertical support 2285, where an overall height of the vertical support 2285 is adjustable. The unitary construction eliminates potential loosening of adjustable connections. In some embodiments, the upper support 2240 is configured to house a charging system as is described in the sections below. The integrated charging system maximizes functionality while minimizing additional components.

The base 2245 portion of the upper support 2240 may extend parallel to a back of the torso 16 of the robot 1 when the robot 1 is standing on the docking station 2200. The parallel orientation ensures uniform load distribution across the contact area. In the illustrative embodiments, the arms 2242 each extend away from the base 2245 in opposite directions while also turning forward such that the distal end 2244 of each of the arms 2242 is oriented in the forward direction, turned 90 degrees with respect to the base 2245. The 90-degree orientation positions the arms 2242 for optimal engagement with the robot's underarm area. In the illustrative embodiment, each of the arms 2242 forms two 45-degree angles to orient the distal ends 2244 at a 90-degree angle relative to the proximate ends 2246. The angular transitions provide smooth load paths while minimizing stress concentrations. In other embodiments, the arms 2242 may form more or fewer angles, or alternatively, may be curved. Curved configurations may provide improved load distribution or aesthetic appeal. The upward slant of the arms 2242 near the proximate ends 2246 enables the upper support 2240 to help prevent the robot 1 from inadvertently sliding off of said upper support 2240. The retention feature ensures secure robot positioning even with minor disturbances.

In the configuration of the upper support 2240 that is shown in the Figures, it should be understood that the uppermost extent of the proximate end 2246 of the arms 2242 should be positioned at a height that is below the uppermost extent of the robot's underarm. The height constraint ensures unobstructed robot docking motion. In other words, the proximate end 2246 of the arms 2242 should not be positioned above the lowermost extent of the torso-shoulder joint. The positioning below the joint prevents interference with shoulder articulation. This positional/height relationship helps ensure that the robot 1 can walk into the docking station 2200 with case and does not have to walk on its toes or perform a non-energy-efficient motion in order to couple itself to said docking station 2200. The natural walking approach minimizes energy consumption during docking procedures. That being said, the height of the proximate end 2246 of the arms 2242 should not be positioned substantially below the upper torso 16 or below the elbow because that would involve the robot 1 bending its knees or a portion of its hips to enable said upper support 2240 to support or partially support said robot 1. The optimal height range balances accessibility with support effectiveness. This is undesirable because it is not energy efficient on docking or undocking and it does not maximize robot storage density. The storage density optimization is particularly significant in facilities housing multiple robots.

In the illustrative embodiment, the forward-facing portions 2249 of the arms 2242 extend parallel to each other and are disposed a distance apart that is substantially equal to a width of an upper portion of the torso 16 of the robot 1 such that each of the arms 2242 extend into a gap between the torso 16 and a respective upper arm of the robot 1, underneath the shoulder 26 joint. The precise spacing ensures reliable engagement without binding or excessive clearance. The arms 2242 are positioned at a height that when the robot 1 backs onto the docking station 2200, the arms 2242 are inserted between the torso 16 and a respective upper arm of the robot 1, underneath the shoulder 26 and provide support and/or contact an upper portion of the torso 16 underneath the shoulders 26. The underarm positioning leverages the natural mechanical advantage of the shoulder structure. In some embodiments, the arms 2242 at least partially support the weight of the robot 1 and/or take at least part of the weight of the robot 1 off the leg assemblies 6 and instead transfer the weight to the docking station 2200 and/or the shoulder joints 26 of the robot 1. The load transfer reduces stress on leg actuators and joints during storage periods. A tip of the distal ends 2244 of the arms 2242 may be angled or flared outward to help guide the robot 1 between the arms 2242 when approaching the docking station 2200. The guiding features facilitate autonomous docking by providing mechanical feedback during approach.

### iii. Lower Support

The lower support or support cradle 2270 projects outwards from the vertical support 2285 below the upper support 2240. The vertical spacing between supports accommodates the robot's torso geometry. A back portion 2272 disposed on a proximate end 2277 of the support cradle 2270 forms a pair of clamps 2273 that extend around the vertical support 2285 to adjustably couple the support cradle 2270 to the vertical support 2285 such that a position of the support cradle 2270 along the vertical support 2285 can be changed. The adjustability allows optimization for different robot models and support preferences. The support cradle 2270 is positioned at a height just below the waist 60 of the robot 1 and near an upper end of upper leg assemblies 6.1 such that when the robot 1 backs into the docking station 2200, the support cradle 2270 is inserted into a gap between the upper leg assemblies 6.1 and below the waist 60. The positioning utilizes the natural spacing in the robot's pelvic region for support engagement. In some embodiments, the support cradle 2270 is positioned to contact the robot 1 below the waist 60 and hip joints and/or take at least some of the weight of the robot 1 off the leg assemblies 6 when the robot 1 is on the docking station 2200. The weight relief on leg assemblies extends component lifetime by reducing continuous loading.

In the illustrative embodiment, the support cradle 2270 is shaped similar to a bicycle seat, with a seat portion 2274 forming an upper surface of the support cradle 2270 disposed closest toward the waist 60 of the robot 1 when the robot 1 is on the docking station 2200. The bicycle seat configuration provides ergonomic support distribution across the pelvic region. The seat portion 2274 may be inclined and/or slant upwards as it extends from the distal end 2276 of the support 2270 to the back portion 2272/proximate end 2277. The inclination assists in guiding the robot into proper position during docking. The slant may help guide the robot 1 onto the support 2270 as the robot 1 backs into the docking station 2200. The guiding action reduces the precision for successful docking alignment. In the illustrative embodiment, the support cradle 2270 includes a gusset 2275 that extends upwards from the lower clamp 2273 to a distal end 2276 of the seat portion 2274 of the support cradle 2270. The gusset 2275 provides a triangulated support structure for enhanced load capacity. The back portion 2272 extends vertically between the gusset 2275 and the seat portion 2274 at the proximate end 2277. The vertical extension creates a rigid support structure connecting to the vertical support 2285. The gusset 2275 may provide additional strength and structure to the support cradle 2270 such that the support cradle 2270 can support at least a portion of the weight of the robot 1. The structural reinforcement ensures long-term durability under repeated loading cycles. A Lip at the distal end 2276 of the seat portion 2274 enables the robot's pelvis to be restrained from sliding out of the cradle once weight is applied and is steep enough and high enough to stop unseating. The retention lip provides passive security against inadvertent robot displacement.

In some embodiments, the support cradle 2270 may be omitted and/or may be differently shaped. The configurability allows optimization for specific robot designs and operational demands. In some embodiments, the support cradle 2270 may be a seat such that the robot 1 sits when docked. The sitting configuration may be preferred for extended storage periods or maintenance operations. In other embodiments, the support cradle 2270 may be shaped similar to the upper support 2240, fitting around the outside of the waist 60 and/or hips of the robot 1. The external hip engagement provides an alternative support strategy that may be preferable for certain robot configurations.

### c. Charging System

In some embodiments, the supports 2240, 2270 may include a charging system capable of charging and/or otherwise electrically connecting to the robot 1. The integrated charging capability eliminates separate charging operations. Various charging systems may be used for charging a battery housed within the humanoid robot 1. The diversity of charging options allows selection based on specific operational demands and constraints. The charging systems may be wire-based or wireless-based systems that may enable the robot 1 to charge said battery. Each charging approach offers distinct advantages in terms of efficiency, convenience, and reliability.

### i. Plug-Based Charging System

The docking station 2200 may include a male electrically connected projection (male connector) that is designed to be received by a female connector formed in the robot 1. The plug-based system provides a reliable electrical connection with minimal resistance losses. Wherein said male connector of the docking station 2200 may be coupled to the support cradle 2270 and is designed to be received by said female connector of the robot 1 when the robot 1 is docked in the docking station 2200. The connector positioning ensures automatic engagement during normal docking procedures. When the robot 1 is docked in the docking station 2200, a high-voltage interlock system is disengaged to allow current to flow from the wall, through the docking station 2200, into the male connector, and then into the female connector of the robot 1. The interlock system provides safety by preventing energization until proper connection is confirmed. This enables direct charging (i.e., not wireless) of the robot's battery. Direct charging provides maximum efficiency with minimal energy loss during transfer.

### ii. Contact Based Charging System

The docking station 2200 may include an embodiment of a contact charging system connected to the humanoid robot 1. Contact charging provides a balance between connection reliability and case of engagement. The contact charging system can have an AC-to-DC converter coupled to the base 2274 that can convert AC from the wall power supply to DC electrical power. The power conversion localization in the docking station simplifies robot design. The illustrated base 2274 can have a positive electrical contact and a negative electrical contact. The dual contact system provides complete circuit connectivity for power transfer. The positive electrical contact and negative electrical contact respectively contact two parts of the humanoid robot 1 to form a closed circuit that enables charging when the robot 1 is standing on the charging station. The contact-based engagement occurs automatically through robot weight. In some embodiments, a negative electrical contact can be on the bottom of the left foot 92 of the robot 1 and the positive electrical contact can be on the bottom of the right foot 92. The foot-based contact location utilizes the natural robot stance for electrical connection. When the robot 1 is standing with both feet 92 in contact with the DC charging contacts, electrical power is transmitted from the contacts to the feet 92 of the robot 1. The standing position ensures consistent contact pressure for reliable power transfer. The DC power from the feet 92 can be transmitted to the battery for recharging. Internal power routing from feet to battery utilizes existing robot wiring infrastructure. Once the battery is charged, the robot 1 can step off of the contacts to stop the battery charging. The simple disconnection procedure involves minimal robot motion or control. The DC voltage can be a set value that can be slightly above the normal fully charged voltage of the robot 1 battery. The voltage differential ensures complete battery charging while preventing overcharge conditions.

The electrical contacts can be arranged in a variety of different configurations, each of which enables the robot 1 to connect to a DC power charger. Configuration flexibility allows optimization for different robot designs and docking approaches. In some embodiments, the robot's positive and negative DC electrical charging contacts can be on the back of the robot torso 16, or the front of the robot torso 16. Torso-mounted contacts may provide more convenient access for maintenance operations. The robot 1 can be charged by coming into contact with a charging wall integrated into the upper support 2240, with the positive and negative DC electrical charging contacts against positive and negative DC electrical charging contacts. The wall-charging configuration maximizes contact area for high current transfer. A proximity sensor, contact sensor, or electrical signals from the robot 1 can be used to determine if the robot 1 is properly connected to the DC electrical charging contacts in either the base 2274 and/or the upper support 2240. Connection verification ensures charging commences only with proper alignment and contact pressure.

In other embodiments, AC electrical power can be applied to the electrical charging contacts. AC power distribution may simplify docking station wiring in certain installations. The AC electrical power can be transmitted to a rectifier to convert the AC electrical power into DC electrical power that can be applied to the battery for charging. Onboard rectification allows for flexible power input configurations. The output DC voltage can be applied directly to the battery for charging or the internal electrical components can convert the applied DC voltage to the proper DC voltage for charging the battery. Voltage regulation ensures optimal charging rates regardless of input variations.

### iii. Foot Based Wireless Charging

The base 2274 of the docking station 2200 may utilize inductive coupling techniques for wireless charging. Wireless charging eliminates mechanical wear associated with physical connectors. In inductive coupling techniques, power is transferred over short distances by magnetic fields using inductive coupling between coils of wire, or by electric fields using capacitive coupling between metal electrodes. The electromagnetic coupling provides power transfer without physical contact. In resonant coupling, a transmitting antenna sends power to a receiving antenna that is tuned to resonate at the transmitted frequency. Resonant tuning maximizes power transfer efficiency at specific frequencies. The physical design of both systems is similar, and both will be discussed here and shown in the same figures. The similarity in physical implementation allows for hybrid systems utilizing both techniques.

An embodiment of an inductive or resonant coupling charging system may include a wireless transmitter having a primary coil that can be provided in the docking area of the docking station 2200 where the robot 1 stands. The floor-mounted coil positioning ensures alignment with robot receiver coils. A wireless receiver having a secondary coil can be mounted in a foot 92 or both feet 92 of a robot 1. Foot-mounted receivers utilize the robot's natural standing position for power coupling. High frequency alternating current can pass through the primary induction coil in or on the floor. The high-frequency operation enables efficient power transfer through compact coil designs. A moving electric charge passing through the primary coil creates a changing magnetic field. The time-varying magnetic field induces voltage in nearby conductive coils. This changing magnetic field is received by a secondary coil(s) in the robot 1. The magnetic coupling enables power transfer across the air gap between coils. The secondary coil(s) creates an alternating electric current. The induced current magnitude depends on the coupling coefficient and load impedance. The alternating electric current can be passed through a rectifier to convert the AC power into DC power that is used to charge the battery of the robot 1. Power conditioning circuits ensure appropriate voltage and current levels for battery charging. The robot 1 can be trained to recognize and connect to the wireless chargers and can preferentially adjust its posture to maintain and/or optimize a charging connection, even if that results in more energy usage from inefficient robot 1 poses. The adaptive positioning capability ensures reliable charging despite minor misalignments.

### iv. Torso Based Wireless Charging

In another embodiment, the inductive charging system is in the upper support 2240 of the docking station 2200. The elevated charging position may provide better coupling efficiency than floor-based systems. The upper support 2240 is configured to house a charging system including a transmitter having a primary coil that creates a changing magnetic field and a receiver having a secondary coil that receives the changing magnetic field from the primary coil. The integrated charging system maintains the compact profile of the upper support 2240. The transmitter is mounted on the base portion of the upper support that contacts the back of the torso 16. The back-mounted configuration utilizes the natural contact area during docking. The robot's wireless receiver is mounted in the torso 16 on the rear of the robot 1. The torso mounting location provides convenient access to the robot's internal power systems. When the receiver on the robot 1 is moved within a certain proximity to the transmitter on the upper support 2240, the secondary coil receives the changing magnetic field from the primary coil to charge the battery. The proximity-based activation ensures charging only occurs when properly docked.

### d. Operational Environment Map

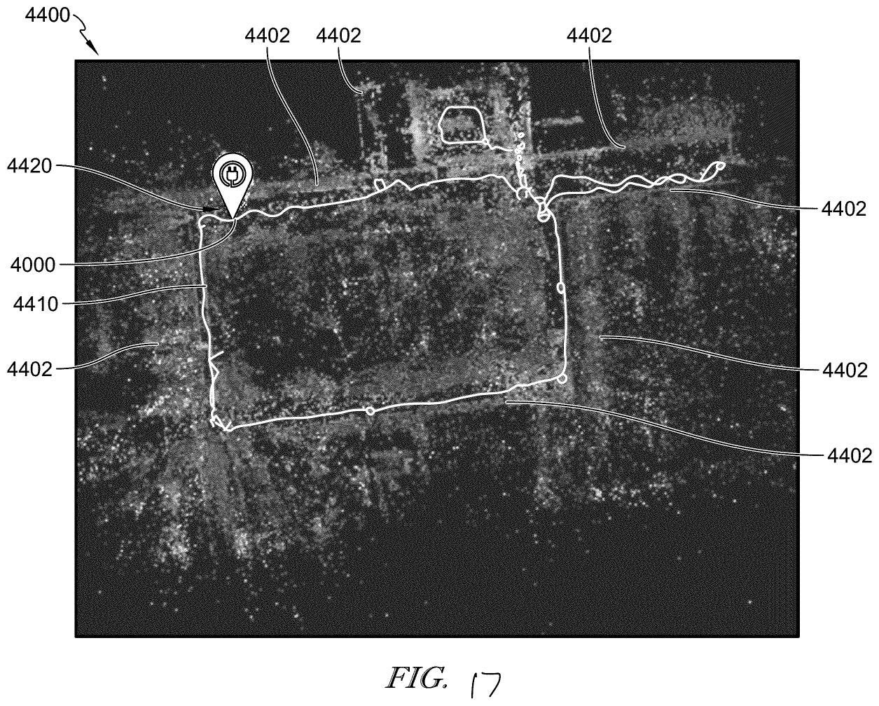

Referring now to FIG. 17, an exemplary operational environment map 4400, which has been generated by the robot 1, is shown. This map 4400 is a digital representation of the robot's physical surroundings, and it can be used by the robot 1 for the purposes of autonomous navigation and task execution. The map 4400 is constructed using a sophisticated algorithm known as Simultaneous Localization and Mapping (SLAM). This algorithm processes data from the robot's various onboard sensors (e.g., LiDAR, depth cameras, IMUs) to simultaneously build the map of the environment and to track the robot's own position within that map. The varying textures and shades that are visible in the map 4400 represent different surfaces, structures, and objects 4402 that the robot 1 has perceived and identified, such as walls, furniture, machinery, or other potential obstacles. The robot's navigation system can recalculate its path for one or more of the following reasons: (i) to maneuver around obstructions by altering its speed or direction based on new environmental data; (ii) to synchronize the movements of its base with its manipulators or other attachments; or (iii) to prevent impacts with other objects. Further, the robot's foot placement controller 1360 is designed to avoid tripping over objects. However, if the robot 1 detects an unrecoverable loss of stability, the robot 1 shall perform an activity, motion, or maneuver that will reduce or attempt to reduce harm to a person, an object, and/or the robot 1 itself.

A robot path or trajectory 4410 is shown overlaid on the map 4400. This path 4410 may represent the historical track of the robot's movement through the environment as it performed its assigned tasks, or it could represent a prospective path that has been planned by the robot's navigation engine 1370 for the purpose of reaching a specific goal location. The path 4410 illustrates the robot's ability to plan and execute complex movements, avoiding the mapped obstacles 4402 in order to travel from a starting point to a destination. The ability to generate and to follow such paths is a cornerstone of the robot's autonomy.

A key feature of the map 4400 is the charging station map icon 4420, which pinpoints the precise location of the docking station 2200. This icon 4420 serves as a persistent waypoint in the robot's memory. When the robot's internal systems detect a low battery state, or at the conclusion of a work cycle, the robot 1 can access this map 4400, identify the location of the charging station map icon 4420, and then autonomously plan and execute a path 4410 to navigate back to the docking station 2200.

In some embodiments, the path planning algorithm can calculate not just the shortest path, but the most energy-optimal trajectory. This advanced functionality enables long-term, independent operation without any human intervention. By minimizing the energy that is expended on the return trip to the charger, the robot 1 can maximize the use of its available power budget for performing its primary assigned tasks. This allows the robot 1 to continue working safely for as long as possible, which reduces the risk of a mission-critical power depletion before it can successfully dock and recharge.

The icon 4420 itself may be initially placed on the map 4400 during a setup or commissioning procedure, or it may be automatically identified and placed by the robot 1 through object recognition of the docking station 2200. Furthermore, in some advanced implementations, the robot 1 can provide feedback to optimize the physical placement of the docking station 2200 within the environment. For example, after operating in the environment for a period of time, the robot 1 can analyze its own historical path data 4410 and its energy consumption patterns. Based on this detailed analysis, the robot 1 could identify a more optimal location for the docking station 2200, for example, a location that is more centrally located to its most frequent work areas or a location that minimizes the average return-to-charge travel time and energy expenditure. The robot 1 could then communicate this data-driven suggestion to a human operator or to a central command system, thereby enabling a more efficient and intelligent workflow for the entire robotic system.

In some embodiments, the robot 1 can act on its own analysis with an even greater degree of autonomy. For example, a robot 1 could be programmed to physically relocate the docking station 2200 itself. In such a scenario, The robot 1 could execute a complex sequence of actions wherein it can first unplug the docking station's power cord from a wall outlet, grasp the docking station 2200 by an integrated handle, and carefully carry the docking station 2200 to the newly identified optimal location. It would then place the docking station 2200, orient it correctly for future docking maneuvers, and use its manipulation skills to plug the power cord back into a different, more conveniently located outlet. This level of self-management and environmental configuration represents a significant leap forward in operational intelligence, creating a truly dynamic and self-optimizing robotic infrastructure.

In some embodiments, the docking station 2200 can be located at the robot's 1 primary work location. For example, the robot 1 may be given a task that does not involve a significant amount of walking, such as an assembly task that involves only an occasional trip to another location to deliver completed assemblies and/or to retrieve more component parts. In such examples, the docking station 2200 can be located such that the robot 1 can rest upon the support cradle 2270, power down some of its motors to conserve energy, and receive charging power, all while the robot 1 is actively performing some or all of its assigned tasks.

### e. Docking Sequence and Mechanical Interface

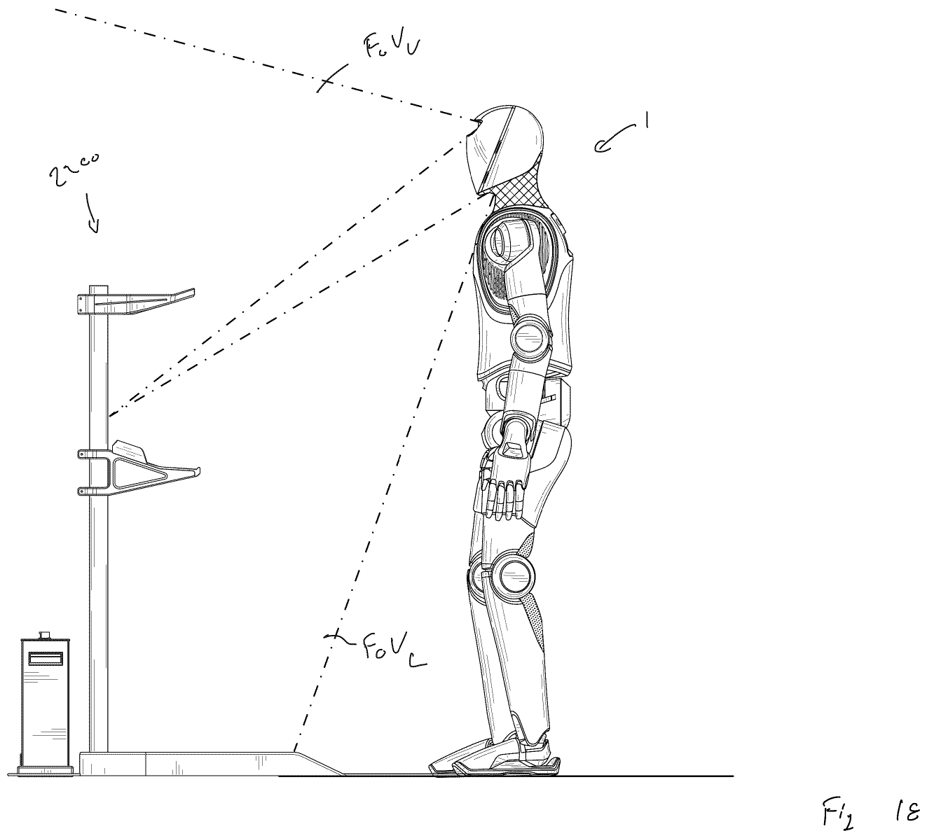

FIGS. 18-20 serve to illustrate the specific sequence of motions and the mechanical interactions that are involved as the robot 1 autonomously docks with the docking station 2200. FIG. 18 depicts the initial approach phase of the docking sequence. Here, the robot 1 is shown walking in a forward direction toward the docking station 2200. In this phase, The robot 1 utilizes its forward-facing vision sensors, specifically the upper camera 108.2.2 and the lower camera 108.2.4, to perceive the docking station 2200. The respective fields of view, designated as FoV_{U} for the upper camera and FoV_{L} for the lower camera, are shown encompassing the docking station 2200. The data that is gathered from these cameras allows the robot's perception system 1420 to identify the docking station 2200, to calculate its distance and orientation relative to the robot's own position, and to perform the gross-level alignment to approach it correctly. This initial phase is fundamentally about establishing the correct initial position and orientation of the robot 1 relative to the target docking station 2200.

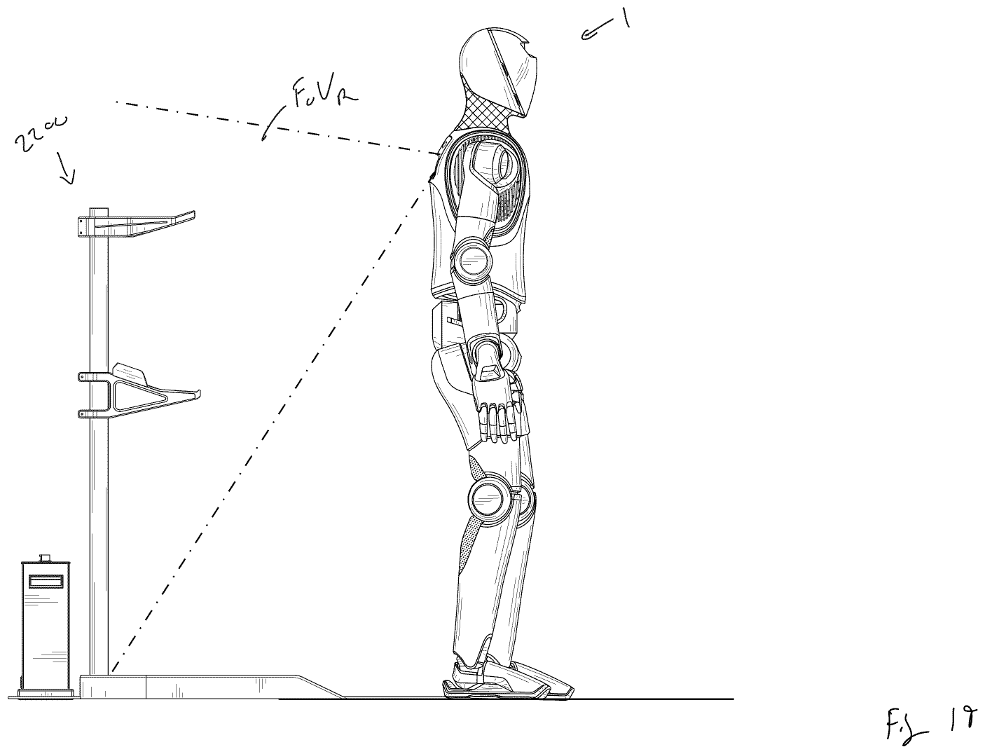

FIG. 19 illustrates the next phase of the sequence: the reverse docking maneuver. Having successfully approached the docking station 2200 and executed a precise 180-degree turn, the robot 1 now uses its rear-facing camera 108.2.6 to guide its backward motion toward the docking station. The field of view, FoV_{R}, of the rear camera 108.2.6 is directed at the support cradle 2270. This provides the high-resolution visual feedback for the robot 1 to precisely align its waist 60 with the support cradle 2270 as it continues to move backward. This step is somewhat analogous to a human driver backing a vehicle into a tight parking space using a rearview camera, and it can be useful for achieving the correct alignment for the subsequent mechanical engagement.

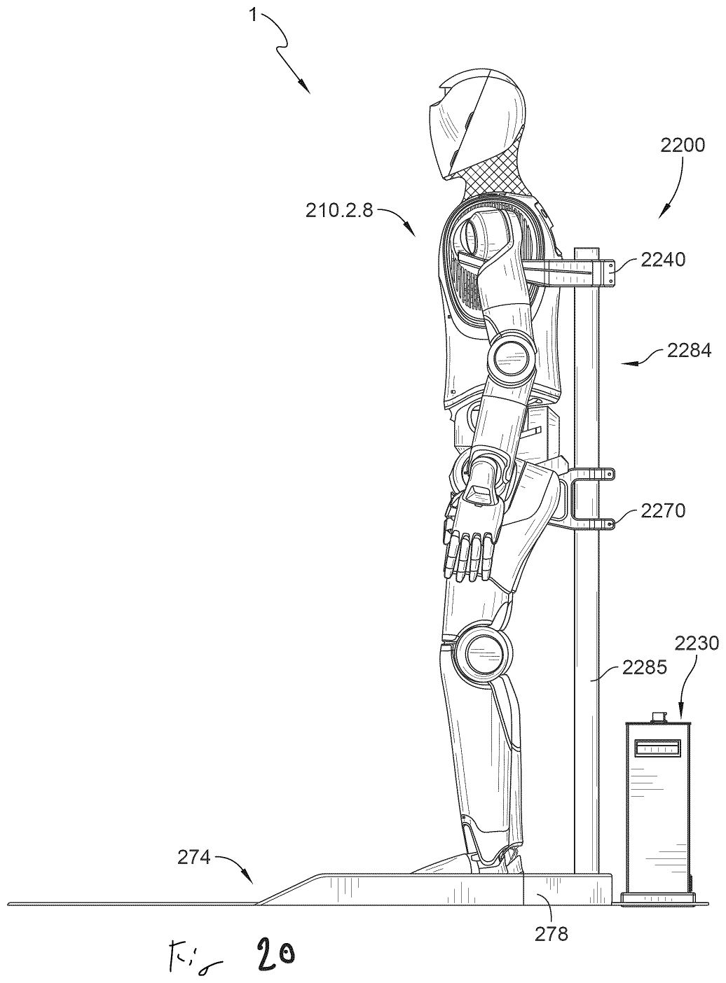

FIG. 20 shows a side view of the robot 1 in the final, fully docked configuration. In this state, The robot's feet 92 are positioned squarely on the base 2274 of the docking station 2200, and it is securely seated in and supported by the support cradle 2270. Notably, the robot's leg assemblies 6 are shown in a slightly bent or “squatted” posture, which is indicated by the articulation of the knee actuator J14. This is not merely a passive slumping motion but is rather a controlled maneuver where the robot 1 actively settles its weight onto the support cradle 2270, an action which simultaneously lowers its overall center of gravity to further enhance its already stable docked state. This relaxed posture is made possible because the weight of the robot 1 is being partially, if not mostly, supported by the external structure of the docking station 2200. This support effectively offloads the energetically demanding task of active balancing from the robot's own systems.

This external support allows the robot 1 to conserve a significant amount of power by de-energizing or substantially reducing power to its powerful leg actuators (such as those in the knee J14 and hip 70) without any risk of losing stability. For a bipedal robot such as the robot 1, maintaining balance while standing still involves constant, subtle actuations and corrections from its motors. This represents a continuous parasitic power drain even when the robot is not performing any other task. By mechanically supporting the robot 1, the docking station 2200 reduces or effectively eliminates this significant power drain. This reduction in power consumption has a direct and highly beneficial impact on the recharging efficiency and speed. Since the incoming power that is supplied by the wireless charger is not being diverted to power the balancing actuators, nearly the full power stream can be dedicated to replenishing the battery cells. This significantly shortens the time for the robot 1 to reach a full charge, which in turn increases its operational availability and overall productivity. Furthermore, by allowing the actuators to rest in a de-energized state during the charging periods, the docking station 2200 also reduces the cumulative mechanical stress and wear on these components. This can lead to a longer operational lifespan and lower maintenance for the robot 1 over time.

### f. Docking and Recharging Process

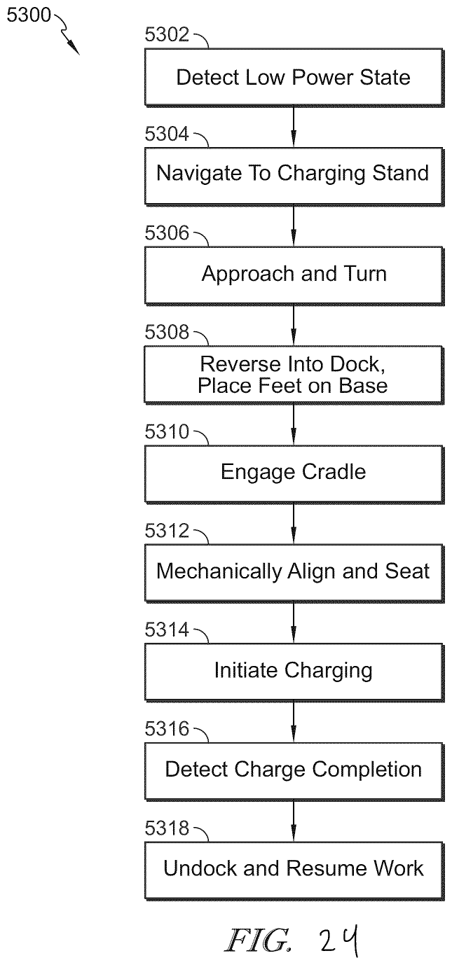

FIG. 24 is a flowchart that delineates an exemplary process 5300 for autonomous docking and recharging. This process enables the humanoid robot 1 to autonomously manage its own power requisites, a capability that addresses the fundamental technical problem of energy management for sustained autonomous operation in dynamic, unstructured environments.

The process is initiated at step S302, which is designated “Detect Low Power State.” The onboard power management system of the robot 1, which may be realized as a sub-component of the main computing architecture, performs continuous monitoring of the state of charge of the internal battery. When the said charge level diminishes to a level that is below a predefined safety threshold, this step is triggered. This threshold is not a static value; rather, it may be a dynamically computed variable, which is calculated by the power management system based on a plurality of factors. These factors may include, but are not limited to, the robot's current distance from the docking station 2200, the calculated energy cost associated with traversing the terrain between its current location and the docking station, and the anticipated power requirements of its currently assigned task. The threshold is strategically established to ensure that the robot 1 always possesses sufficient energy reserves to permit the orderly cessation of its current task, the traversal of the maximum probable distance from its operational area within the environment back to the docking station 2200, and the successful completion of the entire multi-stage docking procedure without any risk of power exhaustion.

Subsequently, at step S304, “Navigate to Docking station,” the navigation routine is initiated by the robot's movement controller 1302. Through the utilization of the stored operational environment map 4400, the current position of the robot 1 is ascertained, as is the stored location of the charging station map icon 4420. An optimal trajectory 4410 to the docking station 2200 is then computed by the navigation engine 1370. The definition of “optimal” may be context-dependent; under normal circumstances, it may signify the most energy-efficient path, whereas under a time-sensitive directive from a user or a central system, it could signify the fastest possible path. The Said path is calculated to be both safe, by avoiding all known static and dynamic obstacles 4402, and efficient, by minimizing any superfluous movements. The robot 1 then commences autonomous locomotion along this newly planned trajectory.

At step S306, “Approach and Turn,” the terminal phase of navigation to the docking station 2200 is executed. As the docking station 2200 is approached, a transition to a precision movement mode is made, which relies upon forward-facing vision sensors, e.g., the cameras 108.2.2 and 108.2.4, for fine-grained visual servoing. During this phase, the robot 1 may use the distinct geometry of the docking station 2200 or a dedicated fiducial marker located thereon to achieve a sub-centimeter level of alignment. Upon reaching a predetermined close-range position relative to the docking station 2200, a controlled, 180-degree pivot turn is executed to orient the robot 1 directly away from the docking station 2200. This maneuver positions the robot 1 for a reverse docking approach, a strategy that optimizes the use of its extensive sensor suite by dedicating the forward-facing sensors for the long-range approach and the rear-facing sensors, such as rear camera 108.2.6, for the high-precision terminal guidance phase, while simultaneously positioning the robot's waist 60 for direct posterior engagement with the support cradle 2270.

Following the turn, at step S308, “Reverse Into Dock, Place Feet on Base,” a deliberate posterior locomotion of the robot 1 toward the docking station 2200 is commenced. This delicate maneuver is guided by a fusion of data from the rear-facing camera 108.2.6 and other proximity sensors, which are used to maintain proper alignment with the target cradle. The foot placement controller 1360 of the robot 1, which is informed by this stream of sensor data, precisely directs the placement of its feet 92 onto a designated wireless charging surface on the base 2274. This step ensures that the power receiver coils located within the feet 92 of the robot 1 are correctly positioned over the transmitter coils of the docking station 2200, so as to maximize the inductive coupling between them.

Once the feet 92 of the robot 1 are securely positioned upon the base 2274, the process advances to step S310, “Engage Cradle.” In this step, a controlled declination, or squatting motion, is executed by the coordinated actuation of the hip and knee joints of the robot. This action smoothly lowers the entire upper body of the robot 1 along a precise vertical vector, thereby bringing its waist 60 into physical contact with the inner surfaces of the support cradle 2270. This is the juncture at which the docking station 2200 commences to bear a substantial portion of the weight of the robot 1, and the control system of the robot 1 begins to receive the initial tactile feedback that confirms physical contact has been made.

At step S312, “Mechanically Align and Seat,” the final seating maneuver is performed. Small, precise adjustments to the position and posture of the robot 1 are made. This is a closed-loop control process, which is guided by continuous tactile feedback from the force-torque sensor arrays located in its waist and hip joints as alignment posts on the support cradle 2270 translate into corresponding concave recesses on its waist 60. The behavior manager 1350 seeks to nullify any detected shear forces, an action which would indicate a sufficient vertical seating of the components. This final mechanical interlocking provides a positive, unambiguous confirmation of correct positioning, ensuring that the robot 1 is both securely and stably seated. This final alignment is of paramount importance for both the mechanical stability of the robot and for the maximization of the efficiency of the subsequent wireless power transfer.

With the robot 1 securely docked, the process proceeds to step S314, “Initiate Charging.” A digital communication signal, often referred to as a “handshake,” is transmitted from the robot 1 to the docking station 2200 to confirm its state of readiness to receive power. This signal may be transmitted via a low-power wireless protocol such as NFC or Bluetooth LE. In response thereto, the docking station 2200 energizes its wireless power transmitter coils, which are located in the base 2274. The power management system of the robot 1 then verifies the receipt of an incoming charge and subsequently transitions the robot 1 into a low-power or standby state in order to conserve energy and to expedite the recharging process by de-energizing non-essential systems, most notably the power-intensive actuators for active balancing.

Contemporaneously with the initiation of the power transfer, the thermal management systems of both the docking station 2200 and the robot 1 may be activated. An airflow channel in the base 2274 is so positioned as to direct a cooling stream of ambient air over the wireless charging surface and the feet 92 of the robot 1, both of which are capable of generating significant heat during high-power inductive charging. Simultaneously, an airflow channel in the support cradle 2270 is aligned with perforated vent panels on the waist 60 of the robot 1, providing an unobstructed conduit for air to be drawn into its own internal torso cooling system. This synergistic thermal management methodology, which leverages features of both the docking station 2200 and the robot 1, is useful for the efficient dissipation of waste heat. This cooperative cooling approach enables the system to support higher charging rates without exceeding the thermal operational limits of the battery or its associated sensitive electronic components.

In some embodiments, the initiation of charging can also activate active cooling features within the docking station 2200, such as internal fans or impellers associated with the airflow channels, in what is an intelligently controlled process. The activation of these features may be triggered by the digital handshake protocol initiated in step S314, wherein the robot 1 can communicate its current thermal state and can request a specific charging profile, such as a standard charge or a rapid charge. The control system of the docking station 2200 can then activate the cooling systems in a manner that is proportional to the requested power draw. Alternatively, the activation of the cooling systems can be predicated on data from thermal sensors integrated within the docking station 2200 itself, which constantly monitor the temperature of the charging coils and power electronics. Upon detecting a temperature that exceeds a predetermined operational threshold, the active cooling systems would be engaged to maintain a safe operating temperature for all components.

The enhancement to the recharging process that is afforded by such active cooling is substantial. A primary limiting factor in the speed of battery recharging is the generation of waste heat. excessive temperatures can cause irreversible damage to battery cells and will prompt the robot's battery management system to thermally throttle, or reduce, the charging current to prevent such damage from occurring. By aggressively and efficiently removing this waste heat at its source, the active cooling systems of the docking station 2200 ensure that the battery remains within its optimal thermal operating window for a longer duration. This prevents thermal throttling and permits the system to sustain a maximal charging current for a longer period of time, which in turn can significantly reduce the total time to achieve a full charge. This ultimately maximizes the operational availability and the overall productivity of the robot 1. Furthermore, by mitigating thermal stress on the components, the system can contribute to the increased longevity of the battery and its associated electronic components.

The charging process persists until the condition of step S316, “Detect Charge Completion,” is met. The battery management system of the robot 1 continuously monitors the state of charge, voltage, and temperature of the battery cells. When the battery has reached its full capacity, a signal is transmitted from the management system to the docking station 2200, instructing it to terminate the power transfer. The docking station 2200 then de-energizes its transmitter coils, and the charging cycle is thereby concluded.

Finally, at step S318, “Undock and Resume Work,” the robot 1 is prepared for its return to service. Upon the receipt of a command from a central command center 2750A-X, an instruction from a human user, or in accordance with a pre-programmed operational schedule, the robot 1 exits its low-power state and performs a full power-on self-test to energize and verify all of its operational systems.

The disengagement process is executed as a substantive and precise reversal of the docking motions, comprising a plurality of coordinated sub-routines. The initial sub-routine involves a pure vertical translation to disengage the robot 1 from the mechanical interlock of the docking station 2200. To achieve this, the robot 1 actuates its hip and knee joints in a coordinated manner to smoothly transition from the rested, squatting posture to a fully erect stance. This motion is controlled by the whole body controller 1550 to generate a smooth, substantially vertical trajectory, so as to prevent any binding or jamming of the alignment posts within the concave recesses. As this vertical motion proceeds, the whole body controller 1550 monitors the progressive transfer of the apparatus's full weight from the support cradle 2270 back onto its own leg assemblies 6, using continuous feedback from force-torque sensors to ensure a controlled and stable load transfer. The motion is considered complete when the waist 60 is lifted fully clear of the support cradle 2270 and the alignment posts are fully disengaged.

A second sub-routine is then executed to verify the robot's postural stability before any locomotion is attempted. With the full weight of the robot 1 now being supported exclusively by its own leg assemblies 6, a stability confirmation sequence is initiated by the whole body controller 1550. This sequence is a useful safety interlock. The controller analyzes a high-frequency stream of data from multiple sensor systems, including the inertial measurement units (IMUs) to ascertain the robot's angular velocity and orientation, and the force-torque sensors located in the feet 92 to determine the precise center of pressure of the ground reaction forces. The controller's balance algorithm compares this real-time data against a dynamic stability model, and it will not permit any forward motion until all metrics, such as body sway and center of mass deviation, are within predefined, safe tolerances. This ensures that the robot 1 will not attempt to walk while it is in an unstable condition.

Upon confirmation of a stable posture, a third sub-routine for egress is executed. The robot 1 subsequently commences forward ambulation, with the foot placement controller 1360 executing the initial, carefully planned steps to move its feet 92 off of the base 2274 and clear of the immediate area of the docking station 2200. The movement controller 1302 ensures this initial egress path is free of any obstacles, utilizing data from the forward-facing vision sensors. Once the robot 1 is physically clear of the docking station 2200, it transitions to a fully operational state, with all of its perceptual, planning, and actuation systems active, thereby rendering it prepared to receive and execute its next assigned task.

### g. Alternative Embodiments

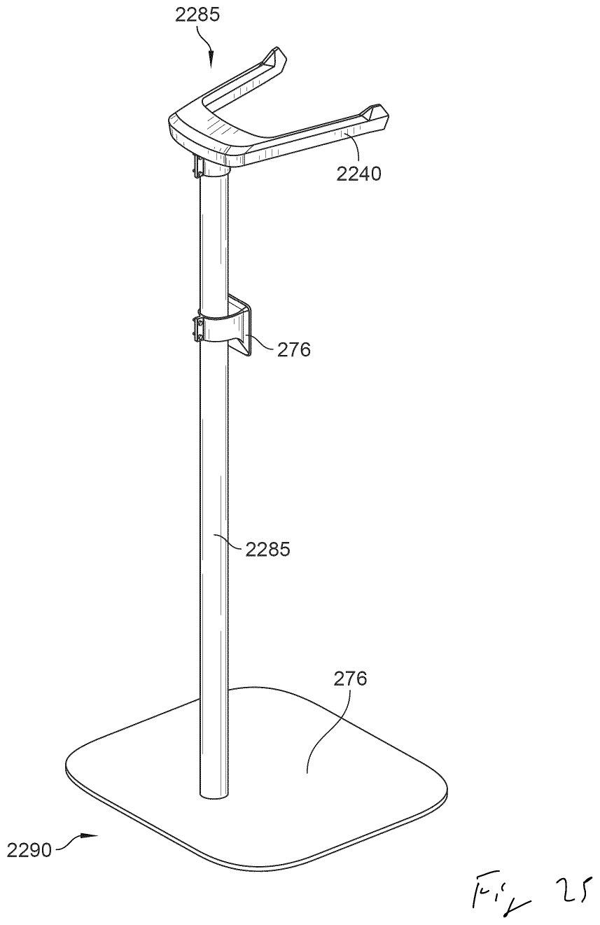

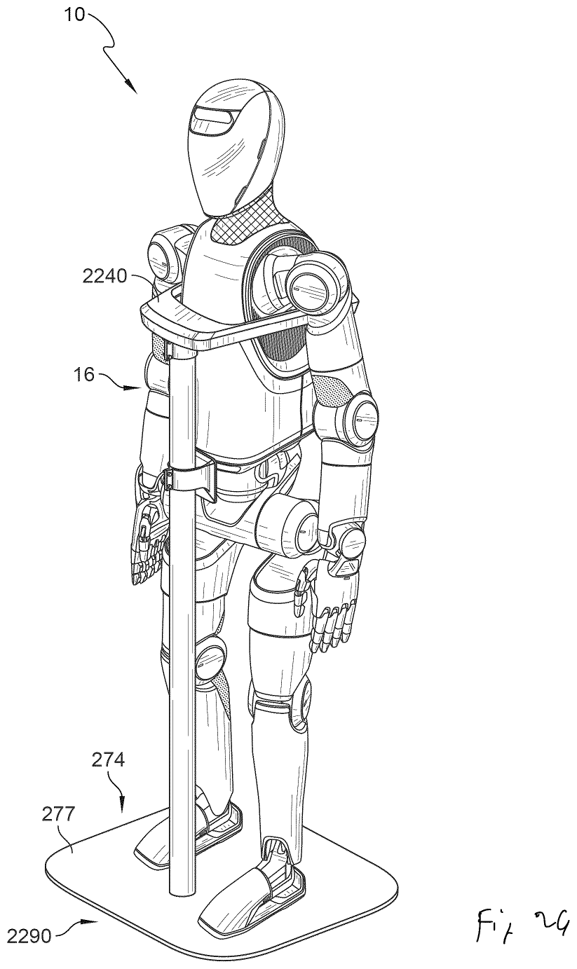

FIGS. 25-26 illustrate alternative embodiments of docking stations. The alternative configurations demonstrate the adaptability of the docking station concept. In one embodiment, as shown in FIG. 25, the docking station omits the platform 2277, and the sidewalls 2278 of the base 2274 rest directly on the underlying surface. The platform omission reduces material costs and installation complexity. In such an embodiment, the docking area where the robot 1 stands when coupled to the docking station is directly on the floor/underlying surface. Direct floor contact may be preferable in facilities with specialized flooring. In other embodiments, the stand assembly 2284 and/or some or all of the supports 2285, 2240, 2270 may be integrated directly into a wall or surface of a building. Building-integrated installations maximize floor space availability. In other embodiments, the base 2274 may omit the sidewalls 2278 and be disposed only directly under the stand assembly 2284. The minimal base configuration reduces the docking station footprint.

In an alternative embodiment, as shown in FIGS. 25-26, the platform of the base of the docking station is a substantially flat surface without sidewalls 2278. The open platform design provides unobstructed robot approach from multiple directions. The platform may only cover the docking area where the robot 1 occupies during docking. The reduced platform size minimizes material usage while maintaining functionality. In some embodiments, as shown in FIGS. 25-26, the robot 1 faces the stand assembly 2284 when on the docking station, with the front of the torso 16 disposed closest to the vertical support 2285. The forward-facing configuration may facilitate certain maintenance operations. In alternative embodiments, the lower support or support cradle 2270 may be omitted from the stand assembly 2284. The single-support configuration simplifies the docking station while maintaining basic functionality.

In further embodiments, the support means 2284 may include: (i) a U-shaped structure that is designed to be positioned below a lower extent of the torso 16, around an extent of a spinal actuator, and above an extent of the pelvis, (ii) only the support cradle 2270 that is designed to be positioned under the robot's pelvis, (iii) only the upper support 2240 that is designed to be positioned under an extent of the robot's arm assemblies 5, or (iv) a clamping member that is coupled to tether points that are located in the robot's neck region, the robot's clavicle regions, or its rear torso region. The variety of support configurations accommodates different robot designs and operational demands. Further, the robot 1 may walk sideways into the docking station 2200 instead of forward or rearward, wherein said U-shaped or fork-like structure can be positioned under a frontal and rear extent of the torso 16 and/or leg assemblies 6. Lateral approach capability provides additional operational flexibility in constrained spaces. Also, the robot 1 may include projections that extend from its pelvis region that are designed to receive or be coupled to an extent of the support means 2284. Robot-mounted projections can provide more secure engagement with a simplified docking station design. In this embodiment, the support members of the stand assembly 2284 may be secured to said projections from the bottom, top, or sides of said projections. Multi-directional engagement options allow for various docking orientations and procedures. Finally, the docking station 2200 may include flexible components designed to further secure the robot 1 to the docking station 2200. Additional securing mechanisms enhance stability during storage and transport. This may be desirable for transport of the robot 1 from a first position to a second position. Transport capability enables robot relocation without complete undocking and re-initialization procedures.

### F. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be applied in all instances. Rather, in some embodiments, such features may be arranged in a different manner or order than shown in the illustrative figures. Additionally, the inclusion of a structural or method feature in a particular figure is not meant to imply that such a feature is present in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 18/922,334, 19/000,626, 19/006,191, 19/033,973, 19/038,657, 19/064,596, 19/180,106, 19/223,945, 19/224,252, 19/249,517, 19/286,240, 19/319,712, 19/324,392, 19/323,751, 19/325,486, 19/325,415, 19/324,342, 19/329,008, 19/329,474, 19/329,485, 19/329,559, 19/337,845, 19/337,852, 19/337,899, 19/347,690, 19/321,022, 19/321,159, 19/347,994, and 19/351,294; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, and 30/026,978, 30/026,981; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, 63/841,314 and 63/691,035, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A docking station for a humanoid robot having a torso, shoulders, and a waist, comprising:
a base configured to support the humanoid robot; and
a stand assembly extending upward from the base and including an upper support configured to be positioned under the shoulders of the humanoid robot to at least partially support a weight of the humanoid robot when the humanoid robot is in a quasi-standing position on the docking station.

2. The docking station of claim 1, wherein the stand assembly further comprises a vertical support extending upward from the base, and wherein the upper support is coupled to the vertical support.

3. The docking station of claim 2, wherein the upper support comprises a pair of arms extending from the vertical support, each arm having a distal end configured to be positioned underneath a respective shoulder of the humanoid robot.

4. The docking station of claim 3, wherein each arm of the pair of arms extends horizontally forward and outward from the vertical support to form a U-shaped support, and wherein the distal ends of the arms are oriented in a forward direction.

5. The docking station of claim 1, wherein the stand assembly further comprises a lower support configured to be positioned under the waist of the humanoid robot to provide additional support to the humanoid robot.

6. The docking station of claim 5, wherein the lower support is shaped similar to a bicycle seat and includes a seat portion forming an upper surface configured to contact the humanoid robot below the waist.

7. The docking station of claim 1, further comprising a charging system configured to charge a battery of the humanoid robot when the humanoid robot is positioned on the docking station.

8. A docking station for a humanoid robot having a torso with shoulders including J2 actuators and a waist, comprising:
a vertical support extending upward from a base;
an upper support coupled to the vertical support and comprising a pair of arms extending horizontally outward from the vertical support, each arm having a distal end configured to be positioned underneath a respective shoulder of the humanoid robot; and
a lower support coupled to the vertical support below the upper support and configured to be positioned under the waist of the humanoid robot.

9. The docking station of claim 8, wherein the upper support is adjustably coupled to the vertical support such that a height of the upper support on the vertical support is adjustable.

10. The docking station of claim 8, wherein each arm of the pair of arms extends away from the vertical support in opposite directions while turning forward such that the distal end of each arm is oriented in a forward direction at a 90-degree angle relative to a proximate end of the arm.

11. The docking station of claim 10, wherein each arm forms two 45-degree angles to orient the distal ends at the 90-degree angle relative to the proximate ends.

12. The docking station of claim 8, wherein the lower support is shaped similar to a bicycle seat and includes a seat portion forming an upper surface configured to contact the humanoid robot below the waist, and wherein the seat portion is inclined and slants upwards as it extends from a distal end of the lower support to a proximate end of the lower support.

13. The docking station of claim 12, wherein the lower support further comprises a gusset extending upwards from a clamp to the distal end of the seat portion to provide structural support for supporting at least a portion of the weight of the humanoid robot.

14. The docking station of claim 8, further comprising a charging system including a transmitter having a primary coil mounted on the upper support and configured to create a changing magnetic field for wirelessly charging a battery of the humanoid robot when a receiver having a secondary coil mounted in the torso of the humanoid robot is positioned within proximity to the transmitter.

15. A method of docking a humanoid robot having a torso, shoulders, and leg assemblies with knee actuators, comprising:
positioning the humanoid robot adjacent to a docking station having a stand assembly with an upper support;
inserting the upper support between the torso and arm assemblies of the humanoid robot such that the upper support is positioned underneath the shoulders; and
reducing power to the knee actuators to allow the humanoid robot to transition from a standing position to a quasi-standing position wherein the upper support at least partially supports a weight of the humanoid robot.

16. The method of claim 15, wherein positioning the humanoid robot adjacent to the docking station comprises walking the humanoid robot backward toward the docking station.

17. The method of claim 15, wherein the docking station further comprises a lower support, and the method further comprises positioning the lower support under a waist of the humanoid robot such that the lower support provides additional support to the humanoid robot in the quasi-standing position.

18. The method of claim 17, wherein the lower support is shaped similar to a bicycle seat and includes a seat portion that contacts the humanoid robot below the waist when the humanoid robot is in the quasi-standing position.

19. The method of claim 15, further comprising charging a battery of the humanoid robot while the humanoid robot is in the quasi-standing position on the docking station using a charging system integrated into the docking station.

20. The method of claim 19, wherein charging the battery comprises wirelessly charging the battery using inductive coupling between a primary coil mounted on the upper support and a secondary coil mounted in the torso of the humanoid robot.
